(19) United States
(12) Patent Application Publication
(10) Pub. No.: US 2025/0203560 A1
(43) Pub. Date: Jun. 19, 2025

(54) Methods and Apparatuses for Positioning Based on Uplink Signals to a Non-terrestrial Network

(71) Applicant: Telefonaktiebolaget LM Ericsson (publ), Stockholm (SE)

(72) Inventors: Iana Siomina, Täby (SE); Åke Busin, Sollentuna (SE); Ritesh Shreevastav, Upplands Väsby (SE)

(21) Appl. No.: 18/847,393

(22) PCT Filed: Mar. 17, 2023
(86) PCT No.: PCT/SE2023/050235

§ 371 Date: Sep. 16, 2024

Related U.S. Application Data
(60) Provisional application No. 63/320,850, filed on Mar. 17, 2022.

(51) Int. Cl. H04W 64/00; H04L 5/00; H04W 56/00; H04W 84/06

(52) U.S. Cl. CPC H04W 64/00; H04L 5/0051; H04W 56/0045; H04W 84/06

(57) ABSTRACT

Methods and apparatuses disclosed herein provide for multiple cell round trip time (multi-RTT) measurements involving a user equipment (UE), where at least one of the multiple cells is associated with a non-terrestrial network (NTN) node. Advantageous operations include determining one or more propagation delays or offsets associated with the feeder and/or service links of the NTN node and determining positioning assistance data based on the delays or offsets. The positioning assistance data accounts for such delays or offsets in the context of measurement configurations and/or transmission timing at the UE and/or the NTN node.

### TECHNICAL FIELD

Methods and apparatuses disclosed herein provide for positioning of user equipments (UEs) based on uplink signals to a non-terrestrial network.

### BACKGROUND

A Non-Terrestrial Network (NTN) typically includes one or several satellite gateways (sat gateways) that connect the Non-Terrestrial Network to a public data network. The NTN further includes one or more satellites, which may be geosynchronous (GEO) satellites or non-GEO satellites, or a mix of both. One or several sat-gateways deployed across a region of targeted satellite coverage feed a GEO satellite, while a non-GEO satellite may be served by a succession of sat-gateways. The NTN may include one or more Unmanned Aerial Systems (UASs) in addition to the satellite(s) or as an alternative to them.

A satellite (or UAS) may implement either a transparent payload or a regenerative payload. Transparent payloads may provide frequency conversion, filtering, and amplification, for signals relay by them but they do not change the waveforms. Conversely, regenerative payloads add processing functions including demodulation/decoding, switch and/or routing, coding/modulation. A regenerative payload is effectively equivalent to having at least some of the functions of a radio base station, such as a “gNB” in the parlance of Third Generation Partnership Project (3GPP) specifications, onboard the satellite or UAS.

Constellations of satellites may also include inter-satellite links (ISL). These links require regenerative payloads on board the satellites. ISL may operate in RF frequency or optical bands.

FIG. 1 lists different types of satellites (or UAS platforms), with corresponding example details.

FIGS. 2-5 illustrate example NTN architectures. In particular, FIG. 2 illustrates a networking-RAN architecture with a “transparent” satellite configuration. FIG. 3 illustrates a regenerative satellite without ISL, and a gNB-processed payload. FIG. 4 illustrates an NG-RAN—Next Generation Radio Access Network—with a regenerative satellite based on a gNB-DU. Here, “DU” connotes “digital unit”, and “NG” refers to Fifth Generation (5G) specifications promulgated by the 3GPP.

Ongoing discussions involving NTNs extend to multi-connectivity scenarios. Multi-connectivity involves transparent or regenerative NTN-based NG-RANs in combination with terrestrial-based NG-RAN (NR or EUTRA) or another NTN. Here, “NR” connotes “New Radio” in the 3GPP 5G context, and “EUTRA” connotes “Evolved Universal Mobile Telecommunications System (UMTS) Terrestrial Radio Access”. EUTRA” relates to Fourth Generation (4G) specifications, i.e., Long Term Evolution (LTE).

A UE may be connected and served simultaneously by at least: one NTN-based NG-RAN and one terrestrial-based access network (e.g., NR or EUTRA), or one NTN-based NG-RAN and another NTN-based NG-RAN. NTNs can have beam-based coverage, as shown in the example coverage scenario depicted in FIG. 6.

The NR architecture is being developed by the 3GPP and FIG. 7 illustrates a contemplated arrangement for performing “positioning” of UEs. Here, a UE is a wireless device or other apparatus that includes radio and processing circuitry configured to access the NG-RAN, e.g., for using the NG-RAN and the associated core network to access other devices or systems reachable via the Internet or one or more other external networks.

UEs may or may not be mobile and may or may not be configured for use by a human user—e.g., in an example case, a UE is a Machine Type Communication (MTC) or Internet-of-Things (IoT) device. Broadly, however, a UE is distinguished from the communication network in that it uses the network, rather than forming a fixed or dedicated part of the network, although it should be understood that a UE may at least temporarily “work” within the network, such as by providing relay or mesh connections for one or more other UEs. The terms “UE” and “wireless device” are interchangeable in this document.

Particularly, FIG. 7 depicts a wireless communication network according to example details from 5G NR. See the 3GPP Technical Specification (TS) 38.300 V15.8.0 (2020-01-08) for an overall description of 5G NR. The network includes a RAN part and a Core Network (CN) part and the lines interconnecting the depicted entities represent communication interfaces between them, for data and control signaling.

The depicted NG RAN includes two or more base stations providing air interfaces according to one or more RATs. For example, the base station labeled “gNB” provides an NR interface, while the base station labeled ng-eNB provides an E-UTRAN interface. Each base station provides one or more transmission/reception points (denoted as “TP”) in the diagram and the base stations are interconnected via an “Xn” interface. The gNB and ng-eNB may not always both be present. When both the gNB and ng-eNB are present, the NG-C interface is only present for one of them.

Depicted CN nodes include an Access and Mobility Management Function (AMF) that provides access and mobility management for UEs supported by the RAN.

Further depicted is a “Location Management Function” or “LMF” that serves as a location node for “positioning” of UEs. Here, “positioning” refers to determining a location of a UE, either in an absolute sense or a relative sense, where positioning may be based on radio measurements made by the RAN and/or the UE being positioned. Such measurements may be based on positioning configuration details provided by the LMF. The LMF may be associated with an evolved serving mobile location center or “E-SMLC.”

The LMF and the UE operate as protocol endpoints for the NR LTE Positioning Protocol (LPP), and positioning interactions between the LMF and base stations involved in the positioning of a UE use a protocol referred to as NRPPa, for example. See 3GPP TS 38.355 V15.9.0 (2020-03-31) for LPP details. The Radio Resource Control (RRC) protocol supports interactions between a UE and a respective base station, for example. See 3GPP TS 38.331 V15.9.0 (2020-03-31) for RRC details.

### SUMMARY

Methods and apparatuses disclosed herein provide for multiple cell round trip time (multi-RTT) measurements involving a user equipment (UE), where at least one of the multiple cells is associated with a non-terrestrial network (NTN) node. Advantageous operations include determining one or more propagation delays or offsets associated with the feeder and/or service links of the NTN node and determining positioning assistance data based on the delays or offsets. The positioning assistance data accounts for such delays or offsets in the context of measurement configurations and/or transmission timing at the UE and/or the NTN node.

An example embodiment comprises a method of supporting multi-RTT measurements involving a UE, where at least one of the multiple cells is associated with a NTN node. The method is performed by the NTN node and includes determining propagation delay information associated with one or both of a feeder link between the NTN node and a ground station, or a service link between the NTN node and the UE. The method further includes sending the propagation delay information to a location server, for determination of multi-RTT assistance data.

A related example embodiment comprises a non-terrestrial network (NTN) node that is configured to support multi-RTT measurements involving a UE, where at least one of the multiple cells is associated with the NTN node. The NTN node includes communication interface circuitry and processing circuitry. The processing circuitry is configured to determine propagation delay information associated with one or both of a feeder link between the NTN node and a ground station, or a service link between the NTN node and the UE, and send, via the communication interface circuitry, the propagation delay information to a location server, for determination of multi-RTT assistance data.

Another example embodiment comprises a method of supporting multi-RTT measurements involving a UE, where at least one of the multiple cells is associated with a NTN node. The method is performed by a location server and includes receiving propagation delay information associated with one or both of a feeder link between the NTN node and a ground station, or a service link between the NTN node and the UE. The method further includes the location server determining multi-RTT assistance data for the NTN node or the UE or both and sending the multi-RTT assistance data to the NTN node or the UE or both.

A related embodiment comprises a location server configured to support multi-RTT measurements involving a UE, where at least one of the multiple cells is associated with a NTN node. The location server includes communication interface circuitry and processing circuitry. The processing circuitry is configured to receive, via the communication interface circuitry, propagation delay information associated with one or both of a feeder link between the NTN node and a ground station, or a service link between the NTN node and the UE. Further, the processing circuitry is configured to determine multi-RTT assistance data for the NTN node or the UE or both, and send, via the communication interface circuitry, the multi-RTT assistance data to the NTN node or the UE or both.

Of course, the present invention is not limited to the above features and advantages. Indeed, those skilled in the art will recognize additional features and advantages upon reading the following detailed description, and upon viewing the accompanying drawings.

### BRIEF DESCRIPTION OF THE DRAWINGS

FIG. 1 is a table listing example types of satellites or UAS platforms.

FIGS. 2-5 are block diagrams of example embodiments of NTNs.

FIG. 6 is a diagram of an example coverage scenario of an NTN.

FIG. 7 is a block diagram of an example 5G NR network arrangement, with support for UE positioning.

FIG. 8 is a block diagram of one embodiment of a communication network.

FIG. 9 is a block diagram of one embodiment of a User Equipment (UE).

FIG. 10 is a block diagram of one embodiment of a non-terrestrial network (NTN) node.

FIG. 11 is a block diagram of one embodiment of a location server.

FIG. 12 is a signal flow diagram of one embodiment of signaling between a location management function (LMF) and respective NTN nodes.

FIG. 13 is a signal flow diagram of one embodiment of signaling between a location server and a UE targeted for positioning—a “target device.”

FIG. 14 is a signal flow diagram of one embodiment of signaling between a location server and one or more NTN nodes, such as one NTN node providing information to a location server or other network node, and one NTN node receiving corresponding assistance data and/or a positioning request.

FIGS. 15-17 are block diagrams illustrating respective embodiments of a wireless device, an NTN node, and a location server, such as may be implemented as processing modules or units.

FIGS. 18 and 19 are logic flow diagrams illustrating example methods of operation at a NTN node and a location server, respectively.

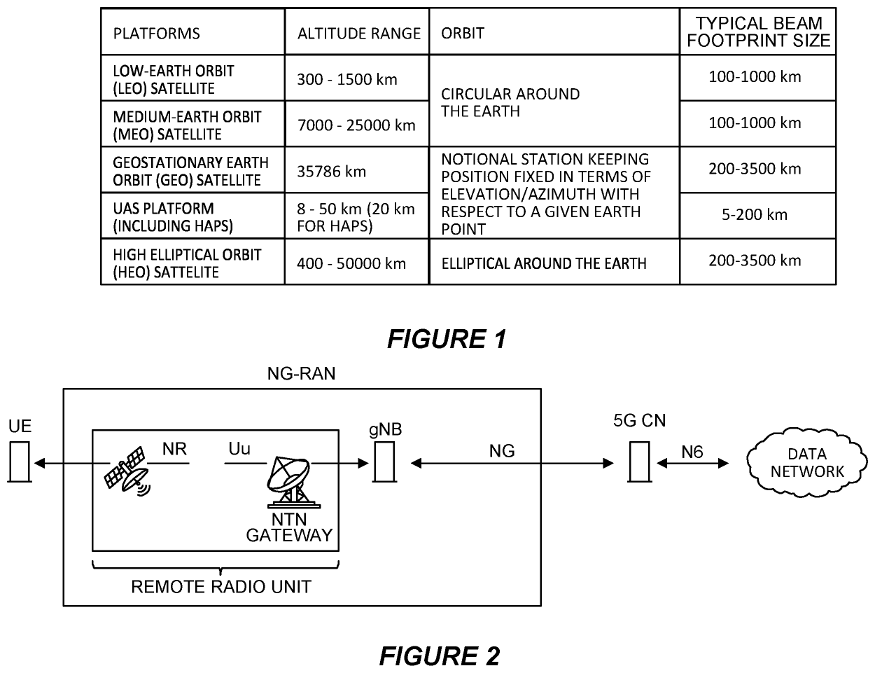

Figure QQ1 is a block diagram of a wireless communication network, according to some embodiments.

Figure QQ2 is a block diagram of a user equipment, according to some embodiments.

Figure QQ3 is a block diagram of a virtualization environment, according to some embodiments.

Figure QQ4 is a block diagram of a communication network with a host computer, according to some embodiments.

Figure QQ5 is a block diagram of a host computer, according to some embodiments.

Figure QQ6 is a flowchart illustrating a method implemented in a communication system, in accordance with one embodiment.

Figure QQ7 is a flowchart illustrating a method implemented in a communication system, in accordance with one embodiment.

Figure QQ8 is a flowchart illustrating a method implemented in a communication system, in accordance with one embodiment.

Figure QQ9 is a flowchart illustrating a method implemented in a communication system, in accordance with one embodiment.

### DETAILED DESCRIPTION

There currently exist certain challenges with respect to positioning when non-terrestrial networks (NTNs) are involved. For example, Global Navigation Satellite System (GNSS) measurements are measurements by a user equipment (UE) of satellite signals received by the UE in the downlink (DL). Such measurements are supported in New Radio (NR) and also in earlier systems. Here, NR is a term used by the Third Generation Partnership Project (3GPP) with respect to Fifth Generation (5G) radio access networks (RANs). However, no measurements are defined for NTN receivers, particularly for positioning purpose, with respect to Uplink (UL) signals transmitted by the UE. Further, there is no signaling support for communicating such measurements to a positioning node, for use in positioning the UE. More broadly, there are no defined positioning procedures or methods based on such measurements.

Certain aspects of the present disclosure and their embodiments may provide solutions to these or other challenges. In one embodiment contemplated herein, new measurements for an UL NTN link comprise a radio measurement for positioning between a UE and an NTN network node, based at least on an UL radio signal transmitted by the UE for reception by the NTN network node. The new NTN measurement can be an UL measurement based only on the UL signal(s) or can be a bidirectional measurement based on the UL signal(s) and DL signal(s) transmitted by the NTN node for reception by the UE.

In another set of embodiments, methods for performing and managing the new measurements are disclosed, along with the necessary signaling support between different ones of the involved nodes. In one example, new protocols are introduced. In a specific example, LPP is extended to accommodate new signaling supporting request, configuration, assistance, reporting, capability, etc., for the new measurements. The extended LPP may be transmitted via the NTN node. In another specific example, NRPPa is extended to accommodate the new signaling, to support the request, configuration, assistance, reporting, capability, etc., for the new measurements. In yet another example, the RRC protocol is extended to accommodate the new signaling, to support request, configuration, assistance, reporting, capability, etc., for the new measurements.

Certain embodiments may provide one or more of the following technical advantage(s): the ability to configure, perform, and use measurements based on UE UL radio signals transmitted to satellite receivers comprised in an NTN, where such measurements are referred to as “new positioning measurements”; signaling support for the new positioning measurements; the ability to use the new positioning measurements in terrestrial network nodes; and the ability to use the new positioning measurements in non-terrestrial network nodes.

In view of the embodiments above, the present disclosure generally includes the embodiments enumerated in the EXAMPLE EMBODIMENTS section below and throughout, where various ones of the embodiments may address one or more of the issues disclosed herein.

Example terminology includes “terrestrial network node”, which denotes a radio network node (e.g., BS, gNB, gNB-DU, gNB-CU, relay or IAB node, radio network controller, TRP, etc.) or a core network node (e.g., MSC, MME, O&M, OSS, SON, positioning node, etc.). “Non-Terrestrial Networks” or “NTNs” refer to networks, or segments of a network, that use an airborne or space-borne vehicle to embark a transmission equipment relay node or base station. Broadly, an NTN network includes non-terrestrial radio equipment used to provide a radio link or links for UEs.

The term “NTN node” denotes one or more radio network nodes or equipment at an airborne or space-borne vehicle, satellite (e.g., LEO, MEO, GEO, HEO, etc.), UAS platform, etc. capable of at least receiving radio signals from UEs operating on the Earth. The receivers of an NTN node may have specific RF characteristics (e.g., sensitivity) and may operate in specific RF bands dedicated for NTN operation. At least in a 5G NR context, an NTN node may also comprise a gNB of a special type, i.e., capable of NTN operation.

Note that while an NTN node includes at least an airborne/spaceborne transmission/reception point—e.g., antennas/radio-circuitry—it may also include, in a distributed sense, one or more ground-based parts or entities that control or manage the non-terrestrial parts. The terms “radio network node” and “base station,” unless otherwise qualified in context, may also be used herein to refer to radio network nodes, NTN nodes, that include at least an airborne/spaceborne transmission/reception point for non-terrestrial radio-link transmission/reception.

The terms location server, positioning node, LMF, and E-SMLC are to be used inter-changeably, unless otherwise noted.

The term “time resource” used herein may correspond to any type of physical resource or radio resource expressed in terms of length of time. Examples of time resources include symbol, time slot, subframe, radio frame, TTI, interleaving time, slot, sub-slot, mini-slot, etc.

According to a disclosed technique for supporting positioning with NTN radio links, one or more NTN nodes, or a UE, or both the NTN node and the UE may be configured to perform new measurements for an NTN radio link, for positioning between UE and the NTN network node. The new measurements include at least UL signal measurements on the NTN UL between the UE and the NTN. In an example case, the involved NTN nodes receive UL signals from the UE via the NTN UL on respective radio links and at least one of the NTN nodes may transmit DL signals on the involved NTN radio link, for use by the UE in making positioning measurements.

The UL radio signal can have physical layer characteristics specific for NTN operation, e.g., sequence parameters, bandwidth, SCS or symbol length, cyclic prefix, sequence generation, etc. In one specific example, the UL radio signal is transmitted in a radio frequency or frequency band dedicated for NTN operation. In another example, the UL radio signal is transmitted in multiple repetitions to compensate for the large distance.

The UL radio signal transmission can also be based on a larger TA (extended TA) than currently supported for terrestrial networks. The corresponding TA offset may need to be accounted for (e.g., subtracted) in the relevant new measurements (e.g., Rx-Tx or RTT involving UL NTN link). This TA offset can be subtracted by the UE or by the location server (provided the latter receives the corresponding information, e.g., from the serving NTN node).

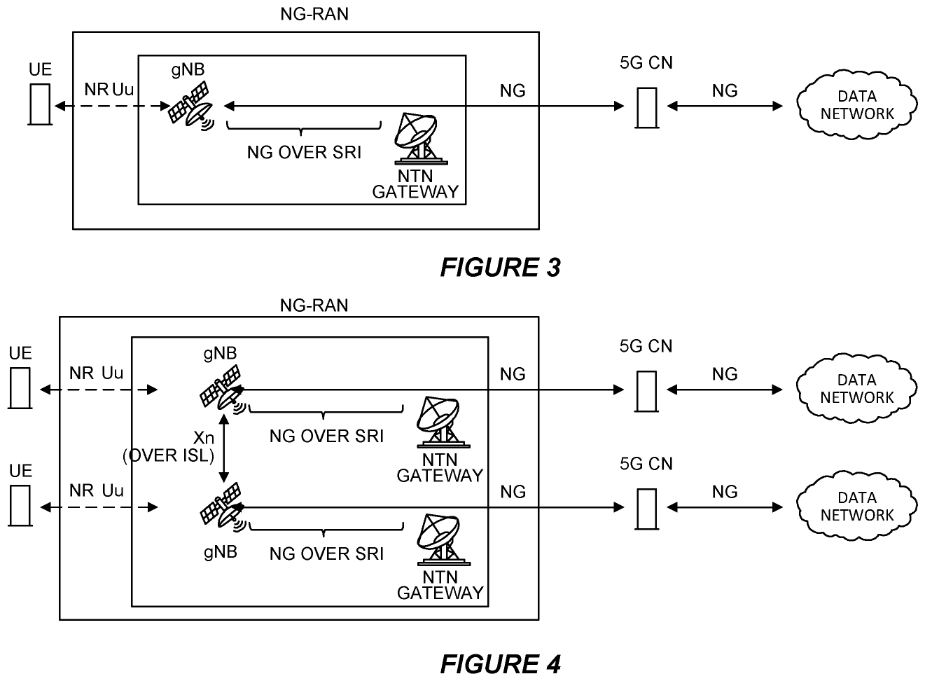

The new measurements can be further characterized by one or more of:
a measurement report mapping range (extended measurement report mapping) adapted to the distance and pathloss travelled by the UL signal, which is different than it would be for a terrestrial network measurement of a similar type;
an extended measurement period compared to what would be needed for a terrestrial network measurement of a similar type (the measurement period can also account for the multiple repetitions of the signals used for the new measurement to compensate for the large distance between the UE and NTN node)—the UE would adapt the measurement procedure accordingly to the extended measurement period and the network node would adapt one or more of their timers to match the extended measurement period;
measurements can be associated with an NTN/satellite beam and its identity (see e.g. FIG. 2) which can e.g. determine how the measurement is performed (e.g., receiving and/or signals associated with the beam, performing measurements on multiple beams, determining the best beam, determining the beam/direction of the reception or transmission prior to performing the measurement, adapting receive antenna configuration to receive in specific direction, receiving/transmitting signals in time and/or frequency resources associated with the beam, etc.) and reported (e.g., report per-beam measurement, etc.);
the measurements may be performed in frequency resources associated with NTN radio operation;
the measurements may comprise the delay or offset (e.g., TA offset) specific for the NTN link; in different examples, the measurement can be reported without or with subtracting this delay/offset (e.g., can be subtracted when the delay/offset can be determined or obtained by the measuring node); and
the measurement report mapping can be adapted or based on the delay or offset (e.g., TA offset) specific for the NTN link, e.g., a larger reporting range due to a possible delay/offset.

The new measurements can be UL measurements (based on the UL signal(s) only) or can be a bidirectional measurement (based on the UL signal(s) and DL signal(s) transmitted by the NTN node and received by the UE on the NTN DL). The UL measurements would then be performed by the NTN node, while the bidirectional measurements can be performed by the UE or by the NTN node.

In one example, the new measurements can be, e.g., a timing measurement (e.g., UL ToA, UL TDOA, UE Rx-Tx time difference, NTN Rx-Tx time difference, RTT, multi-RTT, RToA, measured in time units, Timing Advance, etc.), absolute or relative or differential, single- or bi-directional. In another example, the new measurement can be a power-based measurement (e.g., received signal power or RSRP in dBm or dB for relative power, received signal quality or RSRQ in dB, total received power or interference or RSSI in dBm), absolute or relative or differential. In yet another example, the new measurements can be an angular measurement (e.g., AoA in degrees elevation and azimuth), absolute or relative or differential.

The new measurements can then be used for positioning, e.g., to determine the location of the UE. The positioning can be based either on: only on the new measurements, or a combination of the new measurements and at least one measurement based on terrestrial radio links.

Determining or calculation of the UE location based on the new measurements can be done, e.g., in a location server or an NTN node, or even in the UE (at least in embodiments where the new measurements include bidirectional measurements, including measurements at the UE on the NTN radio link). An LMF stands as one example of a location server.

Methods for performing and managing the new positioning measurements provide flexibility in terms of which node or entity is the “measuring node.” In an example case, an NTN node operates as the measuring node. Here, the “NTN node” operating as the “measuring node” means that the NTN node makes measurements on the NTN radio link, or more particularly, makes measurements on UL signals transmitted by the UE on the NTN UL. (The NTN radio link can be considered as including or providing an NTN UL and an NTN DL.)

When the measuring node for the new positioning measurement is the NTN node (in case of the new UL measurements or the new bidirectional measurements), an example procedure comprises the following, where the individual steps or operations are not necessarily included in all embodiments:
a NTN node receives a request for its capability information on its support for the new measurements;
the NTN node provides its capability information indicative of its ability to support the new measurements (e.g., it provides the information to another node, e.g., another NTN node or a location server);
the NTN node receives request for the new measurements request from another node (e.g., from a location server other than terrestrial network node, or from another NTN node);
the NTN node determines the configuration of the signals (at least UL) to be received by the NTN node for the new measurements, where the determining can be based on a pre-defined rule and/or message from another node (e.g., from a location server or from another NTN node);
for bidirectional measurement such as Rx-Tx time difference, the NTN node may also determine the configuration of the DL signals needed for determining the transmit timing, Tx, (in addition to the receive timing, Rx, of the UL signals);
the NTN node may receive assistance data (e.g., from location server, from terrestrial network node, or from another NTN node) enabling performing the new measurements;
the NTN node performs the new measurements (based on one or more signal samples), based on at least the UL signal with the determined signal configuration;
in a case where the new measurements are beam-based, the measuring NTN node may search over multiple receive beams, unless it knows which one(s) of its receive beams the UE is associated with—for example, if the UE is served via an NTN DL beam, then the NTN node may infer that the same or similar beam direction should be used for receiving NTN UL signals from the UE;
the NTN node performs one or more of the following operational tasks regarding the new measurements:
   (a) report the new measurements to another node (e.g., location server, another NTN node, or a terrestrial network node), and may indicate the NTN cell and/or beam/direction of the UE (e.g., its serving NTN cell and DL NTN beam, and the other node may in turn pass the new measurements further to another node (e.g., location server, another NTN node, or a terrestrial network node);
   (b) determine UE location, using the received new measurements (see below a similar step for NTN node);
   (c) store the new measurements in an internal or external memory or database for further use for positioning (see below a similar step for NTN node);
   (d) determine UE location, using the performed new measurements;
   (e) use the NTN beam/direction information if available and/or its trajectory in determining the UE location (or prior to determining the UE location the NTN node location on its trajectory may need to be determined for the time when the new measurements was performed); or
   (f) store the new measurements in an internal or external memory or database for further use for positioning.

Because the NTN node may be moving—may be a UAS or a non-geostationary satellite, the new measurements can be associated implicitly (e.g., via time) or explicitly with a specific NTN node location on its trajectory.

Now consider a case where the UE is the measuring node for the new measurements. When the measuring node for the new measurements is the UE (the new measurements are new bidirectional measurements), an example procedure comprises a number of operations or steps, where not all steps are performed in all embodiments:
the UE receives a request for its capability information on its support of the new measurement(s);
the UE provides its capability information indicative of its ability to support one or more of the new measurement(s) (e.g., to serving NTN node, location server, or serving terrestrial network node directly or via NTN node);
the UE receives a new measurements (see section 5.2) request from another node (e.g., from a location server or from NTN node or from a terrestrial network node directly or via NTN node);
the UE receives assistance data, which may be referred to as assistance information and may be sent from the NTN node, a terrestrial network node directly or via NTN node, or from a location server via NTN node to enable performing the new measurement;
the UE determines the configuration of the signals (at least DL) to be received by the UE for the new measurements, e.g., the determining can be based on a pre-defined rule and/or message from another node (e.g., from a location server or from serving NTN node or terrestrial network node). The UE also determines the configuration of the UL signals needed for determining the transmit timing, Tx, (in addition to the receive timing, Rx, of the DL signals). The UE may or may not transmit the UL signals, but it at least determines the transmit timing. Here, the assistance data may also be indictive of the NTN cell and/or beam/direction to be assumed for the new measurements; and
the UE performs the new measurements (based on one or more signal samples), based on the determined signal configuration;
for beam-based new measurements, the measuring UE may search over its multiple receive beams and over multiple transmit beams of the NTN node, unless it knows the transmit beam to be received (e.g., determined based on received assistance data);
the UE subtracts the extended TA offset from the measurement or informs the location server about the extended TA;
the UE performs one or more of the following operational tasks for the new measurements, including any one or more of:
   (a) reporting the new measurements to another node (e.g., to NTN node or location server via NTN node or to terrestrial network node directly or via NTN node), based on the extended measurement report mapping, where the node receiving the measurement report needs to determine whether the extended measurement report mapping is used (which can be indicated e.g. by the UE), and the NTN node may also indicate the determined NTN cell and/or beam/direction. The other node may pass the new measurements further to another node (e.g., location server, another NTN node, or a terrestrial network node) or determine UE location, using the new measurements (see below a similar step for UE), or store the new measurements in an internal or external memory or database for further use for positioning (see below a similar step for UE);
   (b) determining the location of the UE, using the new measurements, where the UE may also use the NTN beam/direction information if available (e.g., the UE location is determined to be within the beam coverage area or in the corresponding direction), and may use NTN node trajectory in determining the UE location (or prior to determining the UE location, the location of the NTN node on its trajectory may need to be determined for the time when the new measurements were performed); or
   (c) storing the new measurements in an internal or external memory or database for further use for positioning.

Because the satellites are also moving, but in a pre-defined pattern, the new measurements can be associated implicitly (e.g., via time) or explicitly with a specific NTN node location on its trajectory.

Several additional factors merit consideration regarding the new measurements and attendant configuring, measuring, reporting, and positioning operations. For example, a UE may need to apply a large TA value with respect to an NTN radio link, and the large TA value leads to a large offset in its DL and UL frame timing. NR physical layer timing relationships need to be enhanced to cope with the large offset in the UE's DL and UL frame timing. There may be an offset K_{offset} applied to modify the relevant timing relationships. In such cases, the NTN node may inform the LMF about any offsets applied between the UE's reception of DL Positioning Reference Signals (PRS) transmitted on the NTN DL and the UE's transmission of Sounding Reference Signals (SRS) on the NTN UL, at least where the offsets affect multi-RTT calculations.

UL based positioning methods such as UTDOA or multi-RTT measurements require multiple base stations to listen to the UE transmission (such as UL-SRS). In such cases, UE associated with NRPPa provides a signaling mechanism for providing information about a particular SRS transmission by the UE. Such signaling may be relayed over NGAP protocol. NG Application Protocol timers may have to be extended to cope with the long delay of the feeder link—the link between the terrestrial part of the communication network and the non-terrestrial part, e.g., from a gateway node or other ground station to the airborne/spaceborne equipment. Correspondingly, the LMF is advantageously configured to consider these timing delays in positioning procedures carried out by the LMF, such as procedures involving UTDOA or Multi-RTT.

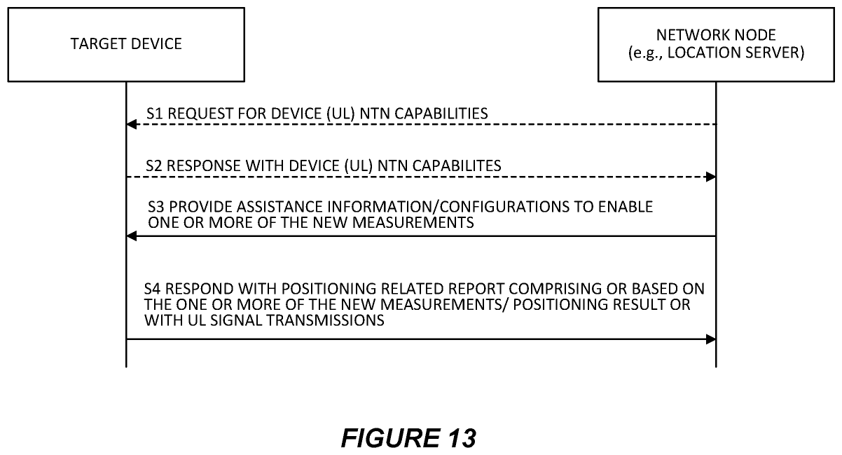

With the above information in mind, FIG. 8 illustrates an example communication network 10 that provides one or more communication services to UEs 12, e.g., by providing access to one or more external networks 14, such as the Internet. In at least one example, the network 10 operates as an access network for communicatively coupling the UEs 12 to one or more external service providers 16 that provide one or more communication services via one or more servers 18.

The communication network 10—“network 10”—includes a non-terrestrial network or NTN as one of its segments. Namely, the network 10 includes a Radio Access Network (RAN) 20 that is non-terrestrial. The NTN RAN 20 includes an NTN node 22 that provides an NTN radio link for serving a UE 12 or is otherwise coupled so as to allow the NTN node 22 to make measurements on the NTN radio link, which will be understood as involving one or more a propagation path or paths between the UE 12 and the NTN node 22.

The NTN RAN 20 in one or more embodiments includes multiple NTN nodes 22, e.g., for receiving uplink (UL) signals transmitted by the UE 12 and performing time-difference-of-arrival (TDOA) or other relative measurements based on receiving the UL signals at more than one reception point in the NTN RAN 20.

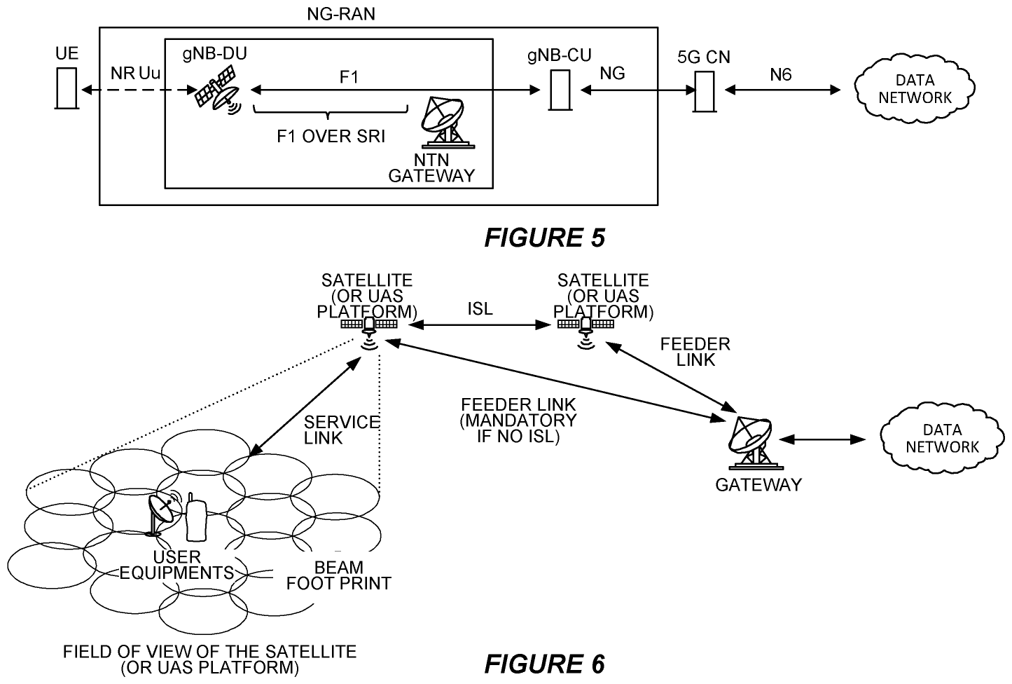

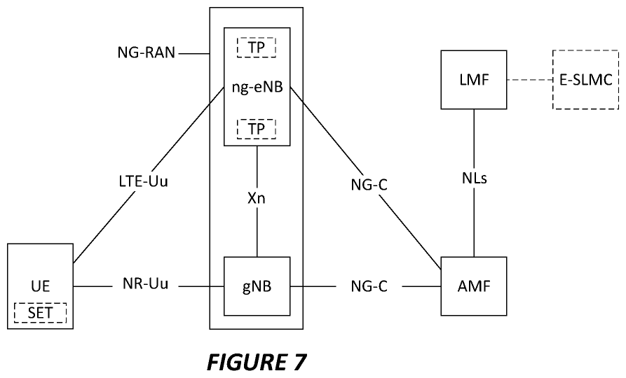

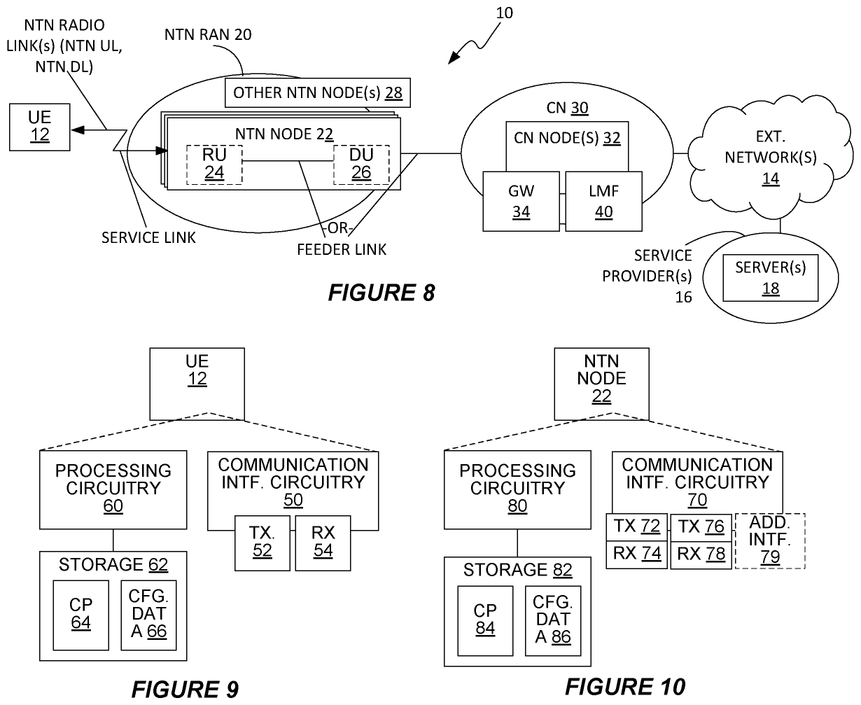

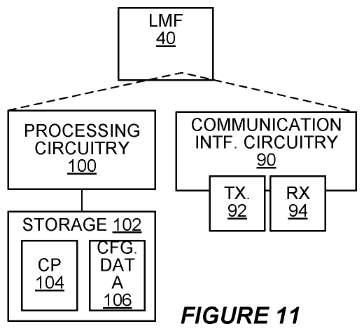

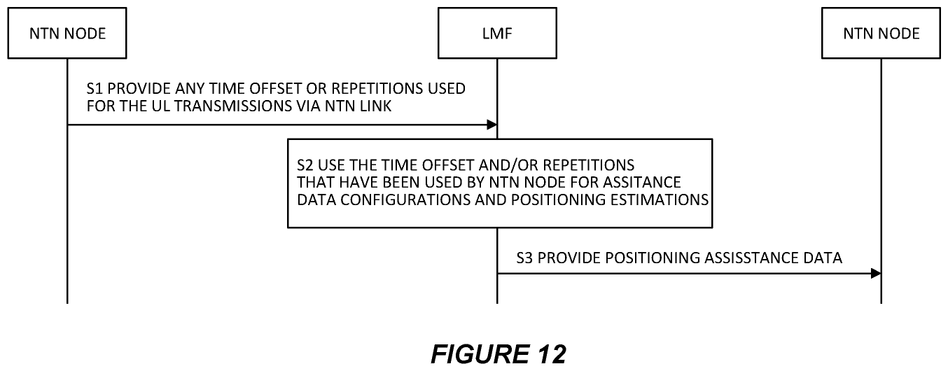

In one or more embodiments, each NTN node 22 includes a Radio Unit (RU) part or parts 24 and a Digital Unit (DU) part or parts 26. The RU part 24 is non-terrestrial, i.e., it resides on a spaceborne or airborne vehicle and provides the NTN radio link. The DU part or parts 26 may be co-located with the RU part or parts 24 (RU parts 24, for brevity). Or the DU part or parts 26 (DU part 26, for brevity) may be terrestrial. Thus, the “feeder link” or ground-station link that communicatively couples the non-terrestrial parts of the NTN RAN 20 to terrestrial parts of the network 10 goes between the DU part 26 and the ground, if the DU part 26 is co-located with the RU part 24. If the DU part 26 is ground-based, the feeder link goes between the RU part 24 and the DU part 26. Satellite gateway and/or interface equipment not depicted may be involved in the feeder link. Refer to FIGS. 2-5 for example details regarding which parts of the NTN RAN 20 may be terrestrial or non-terrestrial and corresponding differences in the nature of the feeder link.

Note that one DU part 26 may support multiple RU parts 24, such that one DU part 26 may be able to transmit and/or receive signals from multiple airborne/spaceborne transmission/reception points in the NTN RAN 20. Further, the NTN RAN 20 may include one or more additional NTN nodes 28, which may be non-terrestrial or terrestrial and which may provide additional supporting functions.

Regarding the new measurements contemplated herein, the NTN node 22 in one or more embodiments is configured to perform NTN UL measurements on UL signals transmitted from the UE 12. Those UL signals and/or the measurement operations are tailored in one or more embodiments to account for the NTN nature of the radio link, which may also be referred to as the “service link.”

For example, the UE 12 transmits the UL signals on radio resources reserved for NTN use (where the network 10 may also include terrestrial radio links, which are not shown). Additionally, or alternatively, the NTN node 22 in one or more embodiments is configured to communicate with one or more other nodes, to support configuration of the NTN node 22 and/or the UE 12, in support of making and reporting the new measurements.

In a particular example, the network 10 includes a Core Network (CN) 30 that includes a number of CN nodes 32, such as one or more gateway nodes 34 for satellite-link coupling to the non-terrestrial parts of the NTN RAN 20. Further, the CN 30 includes or is associated with a Location Management Function (LMF) 40, which may be referred to as a location server or E-SMLC, unless otherwise noted. As disclosed in example arrangements herein, the LMF 40 is configured to support or perform the new measurements used for performing positioning based on the NTN radio link between the UE 12 and the RU 24 of the NTN node 22. Of course, there may be more than one NTN radio link between the UE 12 and the NTN RAN 20, either supported by one RU 24 or by multiple RUs 24, which may be supported by a single DU 26 or by respective DUs 26.

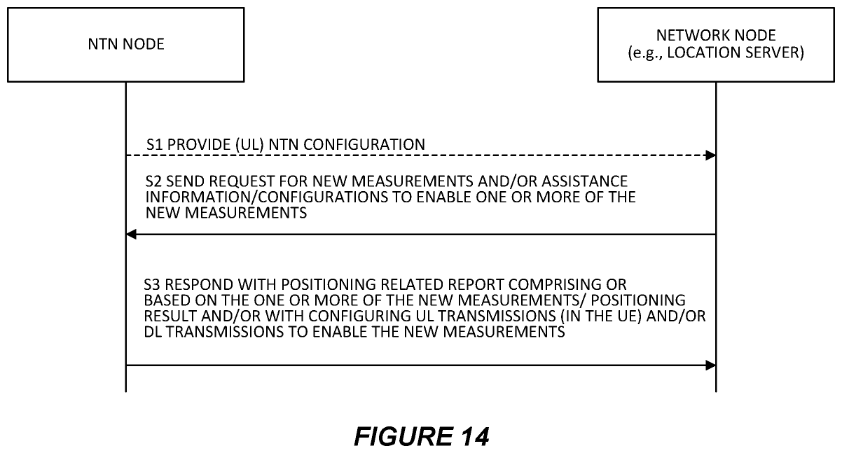

FIG. 9 illustrates an example embodiment of a UE 12. Various elements or components constitute the UE 12, including communication interface circuitry 50, which may include one or more transmitter (TX) circuits 52 and one or more receiver (RX) circuits 54. The communication interface circuitry 50 is configured for sending and receiving radio signals via the NTN radio link.

Other entities or components in the depicted UE 12 include processing circuitry 60, which includes or is associated with storage 62. The processing circuitry 60 comprises fixed circuitry, or preprogrammed circuitry, or programmable circuitry, or any combination of fixed, preprogrammed, and programmable circuitry. Non-limiting examples include one or more microprocessors, microcontrollers, Digital Signal Processors (DSPs), Field Programmable Gate Arrays (FPGAs), Complex Programmable Logic Devices (CPLDs), Application Specific Integrated Circuits (ASICS), or essentially any other arrangement of digital processing circuitry, such as combinational digital logic, sequential digital logic, or both.

In at least one example, the processing circuitry 60 comprises one or more processors—e.g., microprocessors—that are specially adapted to perform any of the UE operations described herein based on executing computer program instructions from one or more computer programs stored in a computer-readable medium providing non-transitory storage for the computer program(s). “Non-transitory” does not necessarily mean unchanging but does connote at least some persistence, and various types of computer-readable media may be involved, such as a mix of non-volatile memory for long-term storage of the computer program(s) and volatile memory as working memory for program execution and scratch data.

Correspondingly, in one or more embodiments, the storage 62 stores one or more computer programs 64 comprising computer program instructions the execution of which by one or more processors yields the processing circuitry 60. The storage 62 may further store one or more items of configuration data 66, based on receiving it during live operation or based on it being pre-stored. The configuration data 66 comprises, for example, information supporting the new measurements for positioning, e.g., information regarding resources to use for the involved positioning signals, or other configuration settings for configuring and performing the new measurements or performing positioning calculations based thereon.

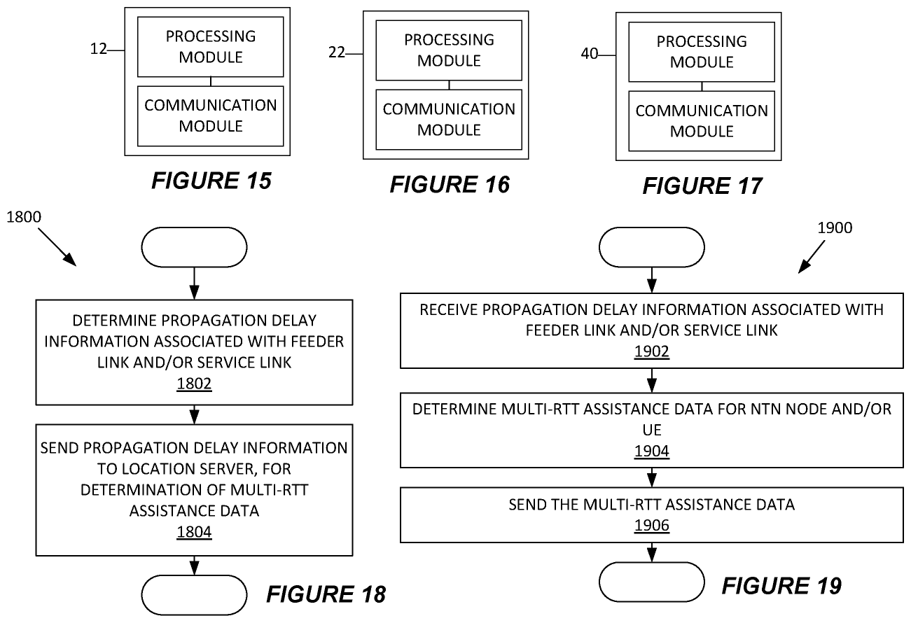

FIG. 10 illustrates an example embodiment of an NTN node 22. Various elements or components constitute the NTN node 22, which, again, may be implemented wholly as a non-terrestrial node, or in distributed form, where a part or parts of the NTN node 22 are non-terrestrial and a part or parts of the NTN node 22 are terrestrial and linked to the non-terrestrial part(s) via one or more satellite feeder links.

The NTN node 22 includes communication interface circuitry 70, which may include one or more transmitter (TX) circuits 72 and one or more receiver (RX) circuits 74. which are configured to provide one or more service links for serving one or more UEs 12—i.e., to provide NTN radio links, each NTN radio link including an NTN UL and an NTN DL. Depending on how the NTN node 22 is implemented, it may include additional types of transmitters 76 and receivers 78, e.g., for coupling to a ground station via one or more feeder links, or for coupling to the non-terrestrial parts of the NTN node 22 via one or more feeder links. Additional communication interface circuitry 79 comprises, for example inter-node interface circuitry, such as network interface circuitry for communicating with the LMF 40 and/or other CN nodes.

Other entities or components in the depicted NTN node 22 include processing circuitry 80, which includes or is associated with storage 82. The processing circuitry 80 comprises fixed circuitry, or preprogrammed circuitry, or programmable circuitry, or any combination of fixed, preprogrammed, and programmable circuitry. Non-limiting examples include one or more microprocessors, microcontrollers, Digital Signal Processors (DSPs), Field Programmable Gate Arrays (FPGAs), Complex Programmable Logic Devices (CPLDs), Application Specific Integrated Circuits (ASICS), or essentially any other arrangement of digital processing circuitry, such as combinational digital logic, sequential digital logic, or both.

In at least one example, the processing circuitry 80 comprises one or more processors—e.g., microprocessors—that are specially adapted to perform any of the NTN node operations described herein based on executing computer program instructions from one or more computer programs stored in a computer-readable medium providing non-transitory storage for the computer program(s). “Non-transitory” does not necessarily mean unchanging but does connote at least some persistence, and various types of computer-readable media may be involved, such as a mix of non-volatile memory for long-term storage of the computer program(s) and volatile memory as working memory for program execution and scratch data.

Correspondingly, in one or more embodiments, the storage 82 stores one or more computer programs 84 comprising computer program instructions the execution of which by one or more processors yields the processing circuitry 80. The storage 82 may further store one or more items of configuration data 86, based on receiving it during live operation or based on it being pre-stored. The configuration data 86 comprises, for example, information supporting the new measurements for positioning, e.g., information regarding resources to use for the involved positioning signals, or other configuration settings for configuring and performing the new measurements or performing positioning calculations based thereon.

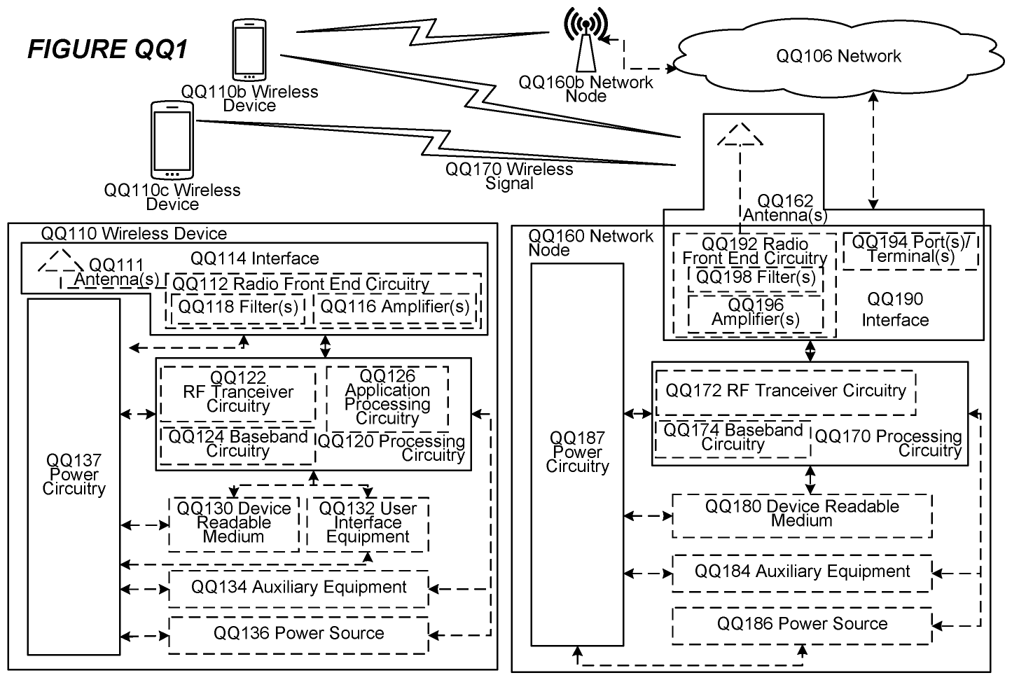

FIG. 11 illustrates an example embodiment of an LMF 40. Various elements or components constitute the LMF 40, including communication interface circuitry 90, which may include one or more transmitter (TX) circuits 92 and one or more receiver (RX) circuits 94, which are configured for communicating with one or more other network nodes or entities, such as for communicating with the NTN node 22 in support of the new positioning measurements and/or for communicating with UEs 12 (e.g., via signaling carried through the NTN node 22 via the provided NTN radio link(s)). For example, the communication interface circuitry 90 supports NR LPP with respect to positioning-related communications with UEs 12 and supports NRPPa with respect to positioning related communications with NTN nodes 22. See 3GPP TS 38.455 V15.2.1 (2019-01-14) and 3GPP TS 38.355 V15.6.0 (2020-01-08) for example NRPPa and NRLPP details, respectively.

Other entities or components in the depicted LMF 40 include processing circuitry 100, which includes or is associated with storage 102. The processing circuitry 100 comprises fixed circuitry, or preprogrammed circuitry, or programmable circuitry, or any combination of fixed, preprogrammed, and programmable circuitry. Non-limiting examples include one or more microprocessors, microcontrollers, Digital Signal Processors (DSPs), Field Programmable Gate Arrays (FPGAs), Complex Programmable Logic Devices (CPLDs), Application Specific Integrated Circuits (ASICS), or essentially any other arrangement of digital processing circuitry, such as combinational digital logic, sequential digital logic, or both.

In at least one example, the processing circuitry 100 comprises one or more processors—e.g., microprocessors—that are specially adapted to perform any of the NTN node operations described herein based on executing computer program instructions from one or more computer programs stored in a computer-readable medium providing non-transitory storage for the computer program(s). “Non-transitory” does not necessarily mean unchanging but does connote at least some persistence, and various types of computer-readable media may be involved, such as a mix of non-volatile memory for long-term storage of the computer program(s) and volatile memory as working memory for program execution and scratch data.

Correspondingly, in one or more embodiments, the storage 102 stores one or more computer programs 104 comprising computer program instructions the execution of which by one or more processors yields the processing circuitry 100. The storage 102 may further store one or more items of configuration data 106, based on receiving it during live operation or based on it being pre-stored. The configuration data 106 comprises, for example, information supporting the new measurements for positioning, e.g., information regarding resources to use for the involved positioning signals, or other configuration settings for configuring and performing the new measurements or performing positioning calculations based thereon.

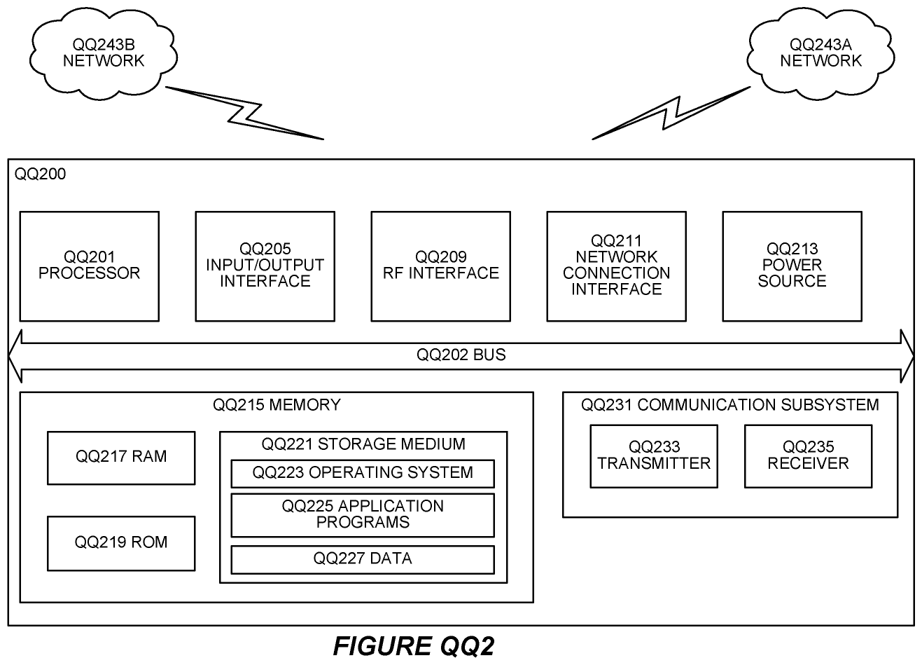

FIG. 12 illustrates an example signal flow diagram between an LMF and an NTN node, e.g., between the above-described LMF 40 and the above-described NTN node 22. Note that there may be multiple NTN nodes 22 involved in positioning a UE 12, e.g., a serving NTN node 22 that cooperates with the UE 12 in terms of configuring and activating UL SRS transmissions by the UE 12, and one or more NTN nodes 22 that “listen” for those transmissions, as received over respective NTN radio links between the UE 12 and each of the listening NTN nodes 22. In this sense, the NTN radio link between a UE 12 and a particular NTN node 22 may be regarded as the propagation path(s) over which transmitted signals are conveyed for reception.

In any case, regarding the depicted NTN node, in an example Step S1, the NTN node provides information to the LMF, indicating the delay involved in UL/DL transmission and NGAP protocol. In at least one embodiment, Step S1 comprises the NTN node determining propagation delay information associated with one or both of a feeder link between the NTN node and a ground station, or a service link between the NTN node and the UE, and sending the propagation delay information to the LMF, for determination of multi-RTT assistance data.

In the illustrated example of Step S2, the LMF uses the time offset and/or signal-repetition information (indicating the number of repetitions to be used by the UE for SRS transmission on the UL), for generating assistance data, for positioning configuration and positioning calculations by one or more nodes. In at least one embodiment, Step S2 comprises the LMF receiving, from the NTN node, propagation delay information associated with one or both of a feeder link between the NTN node and a ground station, or a service link between the NTN node and the UE, and the LMF determining multi-RTT assistance data for the NTN node or the UE or both. The step thus may further include the LMF sending the multi-RTT assistance data to the NTN node or the UE or both.

In one example, the LMF has the responsibility to inform a second NTN node when to listen for UL SRS transmission from UE. Thus, while requesting the first NTN node to activate SRS transmission from a UE served by the first NTN Node, the time instance when the UE should transmit the SRS is included in the NRPPa assistance data and further when the second NTN node should listen to SRS transmission (Step S3).

In another example, the time delay or offset can be used by the LMF to apply a compensation to the measurement on the UL signal transmitted in the presence of this delay or offset, prior to using the compensated measurement for positioning purpose or its one or more operational tasks related to positioning. There may also be multiple UL repetitions to ensure UL coverage. The repetitions also imply the delay involved. The gNB or other involved NTN node may provide such information to the LMF, which may consider it in its position estimations. Such operations may have particular relevance for NTN supporting NB-IoT services.

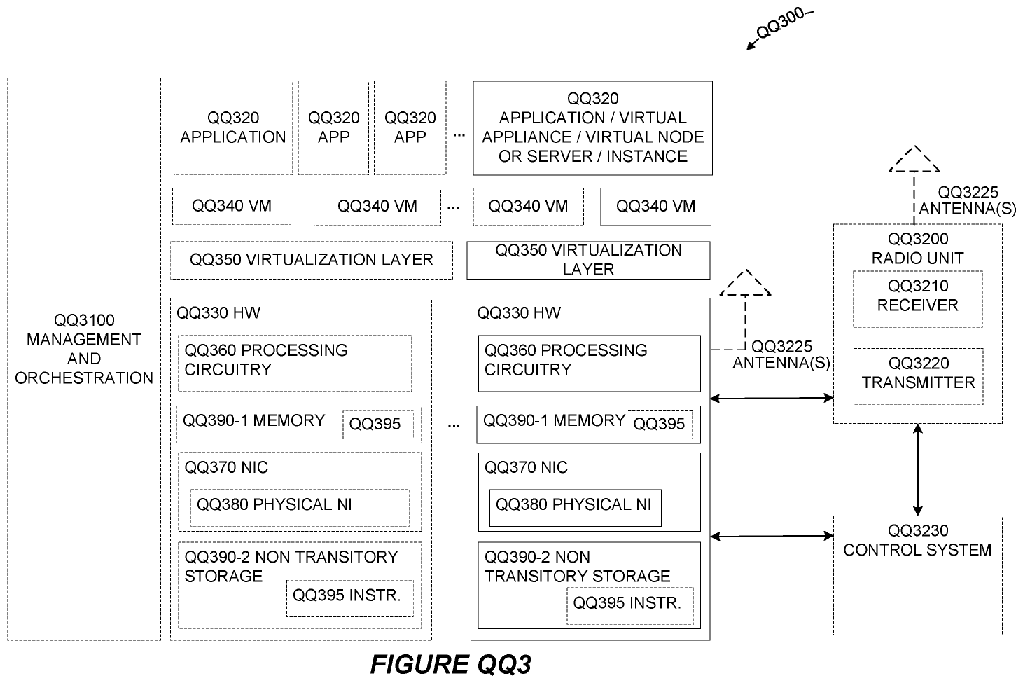

FIG. 13 depicts an example signal flow from the LMF and UE perspective. At Step S1, the Location server (ESMLC, LMF) requests the capabilities (measurement methods and supported measurements associated with UL NTN) from the target device, i.e., a UE 12 to be positioned.

At Step S2, the target device provides the associated capabilities with respect to its NTN-based positioning capabilities.

At Step S3, the target device operating in a cell coverage from an NTN node obtains (specific) configuration/assistance data from the location server, for performing the new measurements (in a bidirectional signaling case), or for transmitting NTN UL signals enabling positioning measurements at one or more NTN nodes (e.g., at respective RUs 24, or, more broadly, at respective non-terrestrial reception points). Based on this configuration, the UE performs the new measurements or transmits the necessary UL signals.

At Step S4, in at least some embodiments, target device provides a response with new measurements report or positioning results report based on the new measurements. In other embodiments, in response to the obtained configuration, the target device may transmit UL signals to be received by NTN nodes. That is, depending on the configuration of the new measurements, the target device transmits the UL signals needed for positioning measurements by the receiving NTN node(s), or it performs positioning measurements based on receiving DL signals—e.g., DL PRS configured by the LMF—and it reports the results of its positioning measurements.

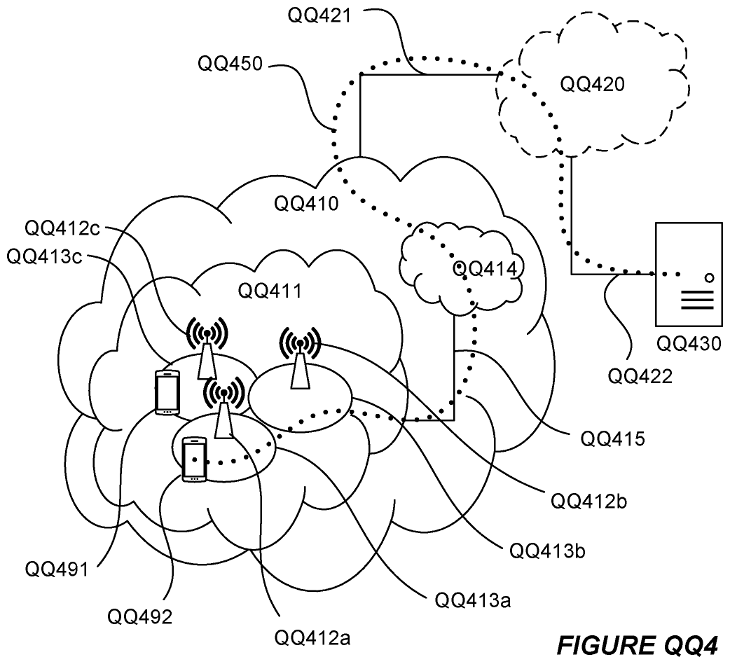

FIG. 14 illustrates an example signal flow from the perspective of a location server and an NTN node.

At Step S1, in some but not necessarily all embodiments, the NTN node provides configuration details such as (transparent or regenerative operation), cells operating in NTN coverage, signal configuration necessary to perform new measurements. The delays or offsets associated with the UL/DL transmission may also be provided.

At Step S2, the location server sends a request for new measurements and/or provides assistance data/configurations to enable one or more of the new measurements. The assistance data may also account for the delays or other information reported in Step S1. The NTN node receiving the assistance data in Step S2 may be the same or different from the NTN node providing the information in Step S1. The “assisted” NTN node, based on the received assistance data, will perform the new measurements and/or configure the necessary UL signals and/or transmit the necessary DL signals.

At Step S3, the NTN node that received the assistance data responds with positioning related report comprising or based on the one or more of the new measurements or positioning result based on the new measurements and/or responds with configuring/triggering UL transmissions (in the UE) and/or responds with configuring DL transmissions to enable the new measurements.

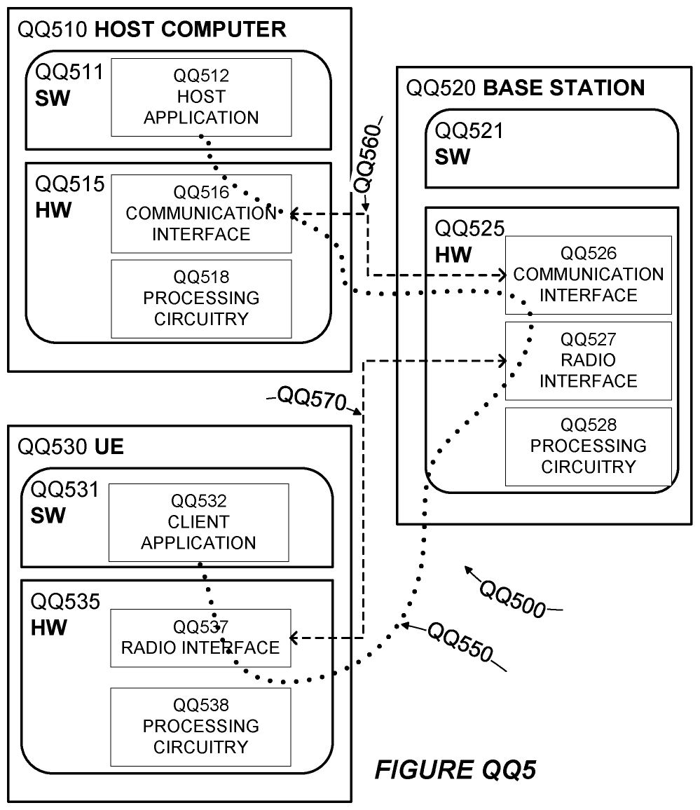

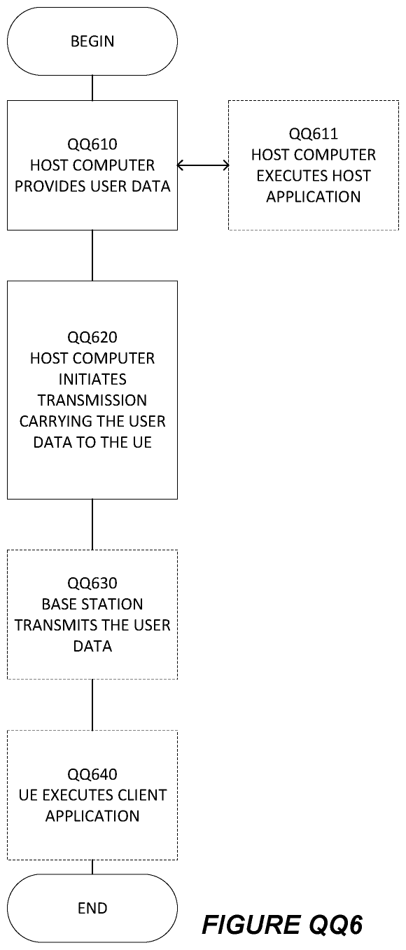

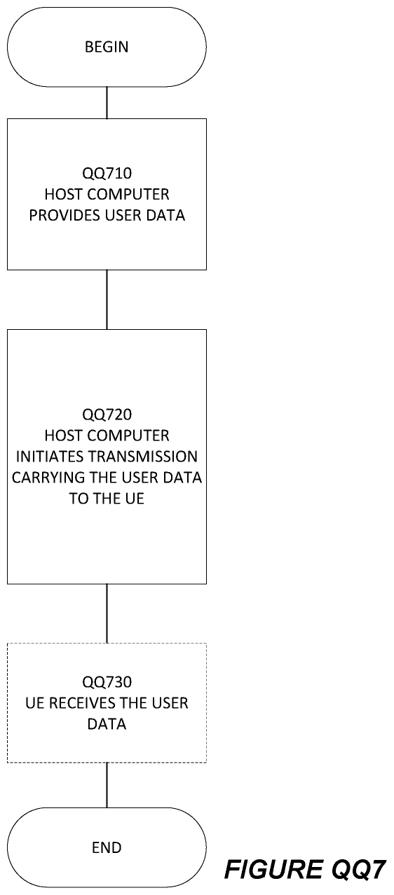

FIGS. 15-17 are block diagrams illustrating respective embodiments of a wireless device, an NTN node, and a location server, such as may be implemented as processing modules or units. The processing modules or units may be virtualized, e.g., such as when they are instantiated in a virtual machine. Of course, it should be understood that the processing units or modules involve underlying processing circuitry.

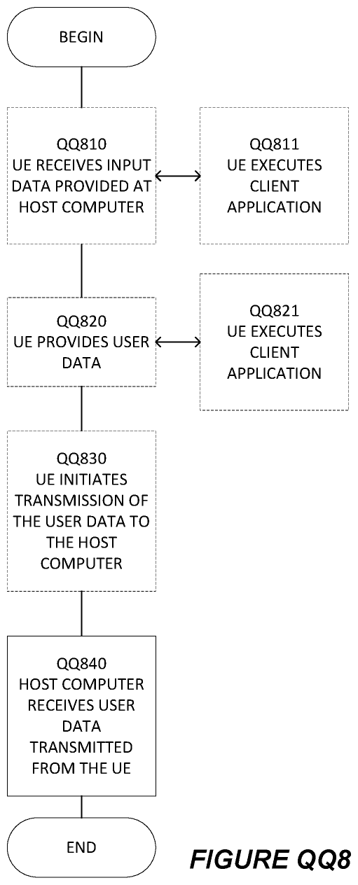

FIG. 18 illustrates an example method 1800 of supporting multiple cell round trip time (multi-RTT) measurements involving a UE, where at least one of the multiple cells is associated with a non-terrestrial network (NTN) node. The method is performed by an NTN node and includes determining (Block 1802) propagation delay information associated with one or both of a feeder link between the NTN node and a ground station, or a service link between the NTN node and a UE. Further, the method includes the NTN node sending (Block 1804) the propagation delay information to a location server, for determination of multi-RTT assistance data.

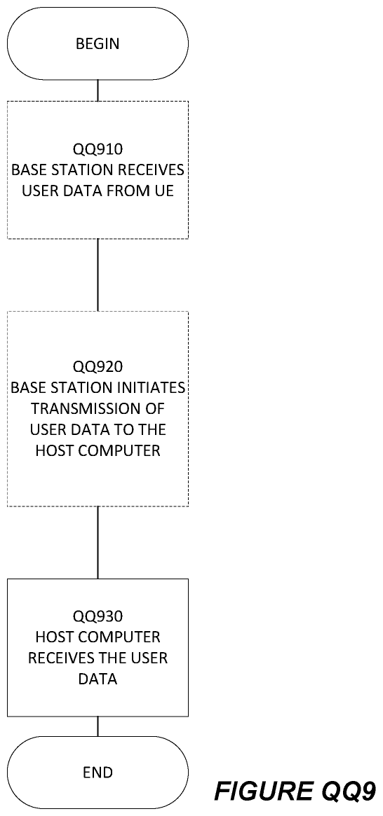

FIG. 19 illustrates another example method of supporting multi-RTT measurements involving a UE, where at least one of the multiple cells is associated with a NTN node. The method is performed by a location server and includes: receiving (Block 1902) propagation delay information associated with one or both of a feeder link between the NTN node and a ground station, or a service link between the NTN node and the UE; determining (Block 1904) multi-RTT assistance data for the NTN node or the UE or both; and sending (Block 1906) the multi-RTT assistance data to the NTN node or the UE or both.

With the above details in mind, embodiments herein also include corresponding apparatuses. Embodiments herein for instance include a wireless device configured to perform any of the steps of any of the embodiments described above for a wireless device.

Embodiments also include a wireless device comprising processing circuitry and power supply circuitry. The processing circuitry is configured to perform any of the steps of any of the embodiments described above for the wireless device. The power supply circuitry is configured to supply power to the wireless device.

Embodiments further include a wireless device comprising processing circuitry. The processing circuitry is configured to perform any of the steps of any of the embodiments described above for the wireless device. In some embodiments, the wireless device further comprises communication circuitry.

Embodiments further include a wireless device comprising processing circuitry and memory. The memory contains instructions executable by the processing circuitry whereby the wireless device is configured to perform any of the steps of any of the embodiments described above for the wireless device.

Embodiments moreover include a user equipment (UE). The UE comprises an antenna configured to send and receive wireless signals. The UE also comprises radio front-end circuitry connected to the antenna and to processing circuitry and configured to condition signals communicated between the antenna and the processing circuitry. The processing circuitry is configured to perform any of the steps of any of the embodiments described above for the wireless device. In some embodiments, the UE also comprises an input interface connected to the processing circuitry and configured to allow input of information into the UE to be processed by the processing circuitry. The UE may comprise an output interface connected to the processing circuitry and configured to output information from the UE that has been processed by the processing circuitry. The UE may also comprise a battery connected to the processing circuitry and configured to supply power to the UE.

Embodiments herein also include a radio network node configured to perform any of the steps of any of the embodiments described above for the radio network node.

Embodiments also include a radio network node comprising processing circuitry and power supply circuitry. The processing circuitry is configured to perform any of the steps of any of the embodiments described above for the radio network node. The power supply circuitry is configured to supply power to the radio network node.

Embodiments further include a radio network node comprising processing circuitry. The processing circuitry is configured to perform any of the steps of any of the embodiments described above for the radio network node. In some embodiments, the radio network node further comprises communication circuitry.

Embodiments further include a radio network node comprising processing circuitry and memory. The memory contains instructions executable by the processing circuitry whereby the radio network node is configured to perform any of the steps of any of the embodiments described above for the radio network node.

Embodiments further include a location server comprising processing circuitry. The processing circuitry is configured to perform any of the steps of any of the embodiments described above for a location server. In some embodiments, the radio network node further comprises communication circuitry, e.g., for communicating with radio network nodes.

Embodiments further include a location server comprising processing circuitry and memory. The memory contains instructions executable by the processing circuitry whereby the location server is configured to perform any of the steps of any of the embodiments described above for the location server.

More particularly, the apparatuses described above may perform the methods herein and any other processing by implementing any functional means, modules, units, or circuitry. In one embodiment, for example, the apparatuses comprise respective circuits or circuitry configured to perform the steps shown in the method figures. The circuits or circuitry in this regard may comprise circuits dedicated to performing certain functional processing and/or one or more microprocessors in conjunction with memory. For instance, the circuitry may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory, cache memory, flash memory devices, optical storage devices, etc. Program code stored in memory may include program instructions for executing one or more telecommunications and/or data communications protocols as well as instructions for carrying out one or more of the techniques described herein, in several embodiments. In embodiments that employ memory, the memory stores program code that, when executed by the one or more processors, carries out the techniques described herein.

Those skilled in the art will also appreciate that embodiments herein further include corresponding computer programs.

A computer program comprises instructions which, when executed on at least one processor of an apparatus, cause the apparatus to carry out any of the respective processing described above. A computer program in this regard may comprise one or more code modules corresponding to the means or units described above.

Embodiments further include a carrier containing such a computer program. This carrier may comprise one of an electronic signal, optical signal, radio signal, or computer readable storage medium.

In this regard, embodiments herein also include a computer program product stored on a non-transitory computer readable (storage or recording) medium and comprising instructions that, when executed by a processor of an apparatus, cause the apparatus to perform as described above.

Embodiments further include a computer program product comprising program code portions for performing the steps of any of the embodiments herein when the computer program product is executed by a computing device. This computer program product may be stored on a computer readable recording medium.

Additional embodiments will now be described. At least some of these embodiments may be described as applicable in certain contexts and/or wireless network types for illustrative purposes, but the embodiments are similarly applicable in other contexts and/or wireless network types not explicitly described.

Although the subject matter described herein may be implemented in any appropriate type of system using any suitable components, the embodiments disclosed herein are described in relation to a wireless network, such as the example wireless network illustrated in Figure QQ1. For simplicity, the wireless network of Figure QQ1 only depicts network QQ106, network nodes QQ160 and QQ160b, and WDs QQ110, QQ110b, and QQ110c. In practice, a wireless network may further include any additional elements suitable to support communication between wireless devices or between a wireless device and another communication device, such as a landline telephone, a service provider, or any other network node or end device. Of the illustrated components, network node QQ160 and wireless device (WD) QQ110 are depicted with additional detail. The wireless network may provide communication and other types of services to one or more wireless devices to facilitate the wireless devices' access to and/or use of the services provided by, or via, the wireless network.

The wireless network may comprise and/or interface with any type of communication, telecommunication, data, cellular, and/or radio network or other similar type of system. In some embodiments, the wireless network may be configured to operate according to specific standards or other types of predefined rules or procedures. Thus, particular embodiments of the wireless network may implement communication standards, such as Global System for Mobile Communications (GSM), Universal Mobile Telecommunications System (UMTS), Long Term Evolution (LTE), Narrowband Internet of Things (NB-IoT), and/or other suitable 2G, 3G, 4G, or 5G standards; wireless local area network (WLAN) standards, such as the IEEE 802.11 standards; and/or any other appropriate wireless communication standard, such as the Worldwide Interoperability for Microwave Access (WiMAX), Bluetooth, Z-Wave and/or ZigBee standards.

Network QQ106 may comprise one or more backhaul networks, core networks, IP networks, public switched telephone networks (PSTNs), packet data networks, optical networks, wide-area networks (WANs), local area networks (LANs), wireless local area networks (WLANs), wired networks, wireless networks, metropolitan area networks, and other networks to enable communication between devices.

Network node QQ160 and WD QQ110 comprise various components described in more detail below. These components work together in order to provide network node and/or wireless device functionality, such as providing wireless connections in a wireless network. In different embodiments, the wireless network may comprise any number of wired or wireless networks, network nodes, base stations, controllers, wireless devices, relay stations, and/or any other components or systems that may facilitate or participate in the communication of data and/or signals whether via wired or wireless connections.

As used herein, network node refers to equipment capable, configured, arranged and/or operable to communicate directly or indirectly with a wireless device and/or with other network nodes or equipment in the wireless network to enable and/or provide wireless access to the wireless device and/or to perform other functions (e.g., administration) in the wireless network. Examples of network nodes include, but are not limited to, access points (APs) (e.g., radio access points), base stations (BSs) (e.g., radio base stations, Node Bs, evolved Node Bs (eNBs) and NR NodeBs (gNBs)). Base stations may be categorized based on the amount of coverage they provide (or, stated differently, their transmit power level) and may then also be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS). Yet further examples of network nodes include multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), core network nodes (e.g., MSCs, MMEs), O&M nodes, OSS nodes, SON nodes, positioning nodes (e.g., E-SMLCs), and/or MDTs. As another example, a network node may be a virtual network node as described in more detail below. More generally, however, network nodes may represent any suitable device (or group of devices) capable, configured, arranged, and/or operable to enable and/or provide a wireless device with access to the wireless network or to provide some service to a wireless device that has accessed the wireless network.

In Figure QQ1, network node QQ160 includes processing circuitry QQ170, device readable medium QQ180, interface QQ190, auxiliary equipment QQ184, power source QQ186, power circuitry QQ187, and antenna QQ162. Although network node QQ160 illustrated in the example wireless network of Figure QQ1 may represent a device that includes the illustrated combination of hardware components, other embodiments may comprise network nodes with different combinations of components. It is to be understood that a network node comprises any suitable combination of hardware and/or software needed to perform the tasks, features, functions and methods disclosed herein. Moreover, while the components of network node QQ160 are depicted as single boxes located within a larger box, or nested within multiple boxes, in practice, a network node may comprise multiple different physical components that make up a single illustrated component (e.g., device readable medium QQ180 may comprise multiple separate hard drives as well as multiple RAM modules).

Similarly, network node QQ160 may be composed of multiple physically separate components (e.g., a NodeB component and a RNC component, or a BTS component and a BSC component, etc.), which may each have their own respective components. In certain scenarios in which network node QQ160 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, network node QQ160 may be configured to support multiple radio access technologies (RATs). In such embodiments, some components may be duplicated (e.g., separate device readable medium QQ180 for the different RATs) and some components may be reused (e.g., the same antenna QQ162 may be shared by the RATs). Network node QQ160 may also include multiple sets of the various illustrated components for different wireless technologies integrated into network node QQ160, such as, for example, GSM, WCDMA, LTE, NR, Wi-Fi, or Bluetooth wireless technologies. These wireless technologies may be integrated into the same or different chip or set of chips and other components within network node QQ160.

Processing circuitry QQ170 is configured to perform any determining, calculating, or similar operations (e.g., certain obtaining operations) described herein as being provided by a network node. These operations performed by processing circuitry QQ170 may include processing information obtained by processing circuitry QQ170 by, for example, converting the obtained information into other information, comparing the obtained information or converted information to information stored in the network node, and/or performing one or more operations based on the obtained information or converted information, and as a result of said processing making a determination.

Processing circuitry QQ170 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node QQ160 components, such as device readable medium QQ180, network node QQ160 functionality. For example, processing circuitry QQ170 may execute instructions stored in device readable medium QQ180 or in memory within processing circuitry QQ170. Such functionality may include providing any of the various wireless features, functions, or benefits discussed herein. In some embodiments, processing circuitry QQ170 may include a system on a chip (SOC).

In some embodiments, processing circuitry QQ170 may include one or more of radio frequency (RF) transceiver circuitry QQ172 and baseband processing circuitry QQ174. In some embodiments, radio frequency (RF) transceiver circuitry QQ172 and baseband processing circuitry QQ174 may be on separate chips (or sets of chips), boards, or units, such as radio units and digital units. In alternative embodiments, part or all of RF transceiver circuitry QQ172 and baseband processing circuitry QQ174 may be on the same chip or set of chips, boards, or units.

In certain embodiments, some or all of the functionality described herein as being provided by a network node, base station, eNB or other such network device may be performed by processing circuitry QQ170 executing instructions stored on device readable medium QQ180 or memory within processing circuitry QQ170. In alternative embodiments, some or all of the functionality may be provided by processing circuitry QQ170 without executing instructions stored on a separate or discrete device readable medium, such as in a hard-wired manner. In any of those embodiments, whether executing instructions stored on a device readable storage medium or not, processing circuitry QQ170 can be configured to perform the described functionality. The benefits provided by such functionality are not limited to processing circuitry QQ170 alone or to other components of network node QQ160 but are enjoyed by network node QQ160 as a whole, and/or by end users and the wireless network generally.

Device readable medium QQ180 may comprise any form of volatile or non-volatile computer readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device readable and/or computer-executable memory devices that store information, data, and/or instructions that may be used by processing circuitry QQ170. Device readable medium QQ180 may store any suitable instructions, data or information, including a computer program, software, an application including one or more of logic, rules, code, tables, etc. and/or other instructions capable of being executed by processing circuitry QQ170 and, utilized by network node QQ160. Device readable medium QQ180 may be used to store any calculations made by processing circuitry QQ170 and/or any data received via interface QQ190. In some embodiments, processing circuitry QQ170 and device readable medium QQ180 may be considered to be integrated.

Interface QQ190 is used in the wired or wireless communication of signalling and/or data between network node QQ160, network QQ106, and/or WDs QQ110. As illustrated, interface QQ190 comprises port(s)/terminal(s) QQ194 to send and receive data, for example to and from network QQ106 over a wired connection. Interface QQ190 also includes radio front end circuitry QQ192 that may be coupled to, or in certain embodiments a part of, antenna QQ162. Radio front end circuitry QQ192 comprises filters QQ198 and amplifiers QQ196. Radio front end circuitry QQ192 may be connected to antenna QQ162 and processing circuitry QQ170. Radio front end circuitry may be configured to condition signals communicated between antenna QQ162 and processing circuitry QQ170. Radio front end circuitry QQ192 may receive digital data that is to be sent out to other network nodes or WDs via a wireless connection. Radio front end circuitry QQ192 may convert the digital data into a radio signal having the appropriate channel and bandwidth parameters using a combination of filters QQ198 and/or amplifiers QQ196. The radio signal may then be transmitted via antenna QQ162. Similarly, when receiving data, antenna QQ162 may collect radio signals which are then converted into digital data by radio front end circuitry QQ192. The digital data may be passed to processing circuitry QQ170. In other embodiments, the interface may comprise different components and/or different combinations of components.

In certain alternative embodiments, network node QQ160 may not include separate radio front end circuitry QQ192, instead, processing circuitry QQ170 may comprise radio front end circuitry and may be connected to antenna QQ162 without separate radio front end circuitry QQ192. Similarly, in some embodiments, all or some of RF transceiver circuitry QQ172 may be considered a part of interface QQ190. In still other embodiments, interface QQ190 may include one or more ports or terminals QQ194, radio front end circuitry QQ192, and RF transceiver circuitry QQ172, as part of a radio unit (not shown), and interface QQ190 may communicate with baseband processing circuitry QQ174, which is part of a digital unit (not shown).

Antenna QQ162 may include one or more antennas, or antenna arrays, configured to send and/or receive wireless signals. Antenna QQ162 may be coupled to radio front end circuitry QQ192 and may be any type of antenna capable of transmitting and receiving data and/or signals wirelessly. In some embodiments, antenna QQ162 may comprise one or more omni-directional, sector or panel antennas operable to transmit/receive radio signals between, for example, 2 GHz and 66 GHZ. An omni-directional antenna may be used to transmit/receive radio signals in any direction, a sector antenna may be used to transmit/receive radio signals from devices within a particular area, and a panel antenna may be a line-of-sight antenna used to transmit/receive radio signals in a relatively straight line. In some instances, the use of more than one antenna may be referred to as MIMO. In certain embodiments, antenna QQ162 may be separate from network node QQ160 and may be connectable to network node QQ160 through an interface or port.

Antenna QQ162, interface QQ190, and/or processing circuitry QQ170 may be configured to perform any receiving operations and/or certain obtaining operations described herein as being performed by a network node. Any information, data and/or signals may be received from a wireless device, another network node and/or any other network equipment. Similarly, antenna QQ162, interface QQ190, and/or processing circuitry QQ170 may be configured to perform any transmitting operations described herein as being performed by a network node. Any information, data and/or signals may be transmitted to a wireless device, another network node and/or any other network equipment.

Power circuitry QQ187 may comprise, or be coupled to, power management circuitry and is configured to supply the components of network node QQ160 with power for performing the functionality described herein. Power circuitry QQ187 may receive power from power source QQ186. Power source QQ186 and/or power circuitry QQ187 may be configured to provide power to the various components of network node QQ160 in a form suitable for the respective components (e.g., at a voltage and current level needed for each respective component). Power source QQ186 may either be included in, or external to, power circuitry QQ187 and/or network node QQ160. For example, network node QQ160 may be connectable to an external power source (e.g., an electricity outlet) via an input circuitry or interface such as an electrical cable, whereby the external power source supplies power to power circuitry QQ187. As a further example, power source QQ186 may comprise a source of power in the form of a battery or battery pack which is connected to, or integrated in, power circuitry QQ187. The battery may provide backup power should the external power source fail. Other types of power sources, such as photovoltaic devices, may also be used.

Alternative embodiments of network node QQ160 may include additional components beyond those shown in Figure QQ1 that may be responsible for providing certain aspects of the network node's functionality, including any of the functionality described herein and/or any functionality necessary to support the subject matter described herein. For example, network node QQ160 may include user interface equipment to allow input of information into network node QQ160 and to allow output of information from network node QQ160. This may allow a user to perform diagnostic, maintenance, repair, and other administrative functions for network node QQ160.

As used herein, wireless device (WD) refers to a device capable, configured, arranged and/or operable to communicate wirelessly with network nodes and/or other wireless devices. Unless otherwise noted, the term WD may be used interchangeably herein with user equipment (UE). Communicating wirelessly may involve transmitting and/or receiving wireless signals using electromagnetic waves, radio waves, infrared waves, and/or other types of signals suitable for conveying information through air. In some embodiments, a WD may be configured to transmit and/or receive information without direct human interaction. For instance, a WD may be designed to transmit information to a network on a predetermined schedule, when triggered by an internal or external event, or in response to requests from the network. Examples of a WD include, but are not limited to, a smart phone, a mobile phone, a cell phone, a voice over IP (VoIP) phone, a wireless local loop phone, a desktop computer, a personal digital assistant (PDA), a wireless cameras, a gaming console or device, a music storage device, a playback appliance, a wearable terminal device, a wireless endpoint, a mobile station, a tablet, a laptop, a laptop-embedded equipment (LEE), a laptop-mounted equipment (LME), a smart device, a wireless customer-premise equipment (CPE). a vehicle-mounted wireless terminal device, etc. A WD may support device-to-device (D2D) communication, for example by implementing a 3GPP standard for sidelink communication, vehicle-to-vehicle (V2V), vehicle-to-infrastructure (V2I), vehicle-to-everything (V2X) and may in this case be referred to as a D2D communication device. As yet another specific example, in an Internet of Things (IoT) scenario, a WD may represent a machine or other device that performs monitoring and/or measurements and transmits the results of such monitoring and/or measurements to another WD and/or a network node. The WD may in this case be a machine-to-machine (M2M) device, which may in a 3GPP context be referred to as an MTC device. As one particular example, the WD may be a UE implementing the 3GPP narrow band internet of things (NB-IoT) standard. Particular examples of such machines or devices are sensors, metering devices such as power meters, industrial machinery, or home or personal appliances (e.g., refrigerators, televisions, etc.) personal wearables (e.g., watches, fitness trackers, etc.). In other scenarios, a WD may represent a vehicle or other equipment that is capable of monitoring and/or reporting on its operational status or other functions associated with its operation. A WD as described above may represent the endpoint of a wireless connection, in which case the device may be referred to as a wireless terminal. Furthermore, a WD as described above may be mobile, in which case it may also be referred to as a mobile device or a mobile terminal.

As illustrated, wireless device QQ110 includes antenna QQ111, interface QQ114, processing circuitry QQ120, device readable medium QQ130, user interface equipment QQ132, auxiliary equipment QQ134, power source QQ136 and power circuitry QQ137. WD QQ110 may include multiple sets of one or more of the illustrated components for different wireless technologies supported by WD QQ110, such as, for example, GSM, WCDMA, LTE, NR, Wi-Fi, WiMAX, NB-IoT, or Bluetooth wireless technologies, just to mention a few. These wireless technologies may be integrated into the same or different chips or set of chips as other components within WD QQ110.

Antenna QQ111 may include one or more antennas or antenna arrays, configured to send and/or receive wireless signals, and is connected to interface QQ114. In certain alternative embodiments, antenna QQ111 may be separate from WD QQ110 and be connectable to WD QQ110 through an interface or port. Antenna QQ111, interface QQ114, and/or processing circuitry QQ120 may be configured to perform any receiving or transmitting operations described herein as being performed by a WD. Any information, data and/or signals may be received from a network node and/or another WD. In some embodiments, radio front end circuitry and/or antenna QQ111 may be considered an interface.

As illustrated, interface QQ114 comprises radio front end circuitry QQ112 and antenna QQ111. Radio front end circuitry QQ112 comprise one or more filters QQ118 and amplifiers QQ116. Radio front end circuitry QQ112 is connected to antenna QQ111 and processing circuitry QQ120 and is configured to condition signals communicated between antenna QQ111 and processing circuitry QQ120. Radio front end circuitry QQ112 may be coupled to or a part of antenna QQ111. In some embodiments, WD QQ110 may not include separate radio front end circuitry QQ112; rather, processing circuitry QQ120 may comprise radio front end circuitry and may be connected to antenna QQ111. Similarly, in some embodiments, some or all of RF transceiver circuitry QQ122 may be considered a part of interface QQ114. Radio front end circuitry QQ112 may receive digital data that is to be sent out to other network nodes or WDs via a wireless connection. Radio front end circuitry QQ112 may convert the digital data into a radio signal having the appropriate channel and bandwidth parameters using a combination of filters QQ118 and/or amplifiers QQ116. The radio signal may then be transmitted via antenna QQ111. Similarly, when receiving data, antenna QQ111 may collect radio signals which are then converted into digital data by radio front end circuitry QQ112. The digital data may be passed to processing circuitry QQ120. In other embodiments, the interface may comprise different components and/or different combinations of components.

Processing circuitry QQ120 may comprise a combination of one or more of a microprocessor, controller, microcontroller, central processing unit, digital signal processor, application-specific integrated circuit, field programmable gate array, or any other suitable computing device, resource, or combination of hardware, software, and/or encoded logic operable to provide, either alone or in conjunction with other WD QQ110 components, such as device readable medium QQ130, WD QQ110 functionality. Such functionality may include providing any of the various wireless features or benefits discussed herein. For example, processing circuitry QQ120 may execute instructions stored in device readable medium QQ130 or in memory within processing circuitry QQ120 to provide the functionality disclosed herein.

As illustrated, processing circuitry QQ120 includes one or more of RF transceiver circuitry QQ122, baseband processing circuitry QQ124, and application processing circuitry QQ126. In other embodiments, the processing circuitry may comprise different components and/or different combinations of components. In certain embodiments processing circuitry QQ120 of WD QQ110 may comprise a SOC. In some embodiments, RF transceiver circuitry QQ122, baseband processing circuitry QQ124, and application processing circuitry QQ126 may be on separate chips or sets of chips. In alternative embodiments, part or all of baseband processing circuitry QQ124 and application processing circuitry QQ126 may be combined into one chip or set of chips, and RF transceiver circuitry QQ122 may be on a separate chip or set of chips. In still alternative embodiments, part or all of RF transceiver circuitry QQ122 and baseband processing circuitry QQ124 may be on the same chip or set of chips, and application processing circuitry QQ126 may be on a separate chip or set of chips. In yet other alternative embodiments, part or all of RF transceiver circuitry QQ122, baseband processing circuitry QQ124, and application processing circuitry QQ126 may be combined in the same chip or set of chips. In some embodiments, RF transceiver circuitry QQ122 may be a part of interface QQ114. RF transceiver circuitry QQ122 may condition RF signals for processing circuitry QQ120.

In certain embodiments, some or all of the functionality described herein as being performed by a WD may be provided by processing circuitry QQ120 executing instructions stored on device readable medium QQ130, which in certain embodiments may be a computer-readable storage medium. In alternative embodiments, some or all of the functionality may be provided by processing circuitry QQ120 without executing instructions stored on a separate or discrete device readable storage medium, such as in a hard-wired manner. In any of those particular embodiments, whether executing instructions stored on a device readable storage medium or not, processing circuitry QQ120 can be configured to perform the described functionality. The benefits provided by such functionality are not limited to processing circuitry QQ120 alone or to other components of WD QQ110, but are enjoyed by WD QQ110 as a whole, and/or by end users and the wireless network generally.

Processing circuitry QQ120 may be configured to perform any determining, calculating, or similar operations (e.g., certain obtaining operations) described herein as being performed by a WD. These operations, as performed by processing circuitry QQ120, may include processing information obtained by processing circuitry QQ120 by, for example, converting the obtained information into other information, comparing the obtained information or converted information to information stored by WD QQ110, and/or performing one or more operations based on the obtained information or converted information, and as a result of said processing making a determination.

Device readable medium QQ130 may be operable to store a computer program, software, an application including one or more of logic, rules, code, tables, etc. and/or other instructions capable of being executed by processing circuitry QQ120. Device readable medium QQ130 may include computer memory (e.g., Random Access Memory (RAM) or Read Only Memory (ROM)), mass storage media (e.g., a hard disk), removable storage media (e.g., a Compact Disk (CD) or a Digital Video Disk (DVD)), and/or any other volatile or non-volatile, non-transitory device readable and/or computer executable memory devices that store information, data, and/or instructions that may be used by processing circuitry QQ120. In some embodiments, processing circuitry QQ120 and device readable medium QQ130 may be considered to be integrated.

User interface equipment QQ132 may provide components that allow for a human user to interact with WD QQ110. Such interaction may be of many forms, such as visual, audial, tactile, etc. User interface equipment QQ132 may be operable to produce output to the user and to allow the user to provide input to WD QQ110. The type of interaction may vary depending on the type of user interface equipment QQ132 installed in WD QQ110. For example, if WD QQ110 is a smart phone, the interaction may be via a touch screen; if WD QQ110 is a smart meter, the interaction may be through a screen that provides usage (e.g., the number of gallons used) or a speaker that provides an audible alert (e.g., if smoke is detected). User interface equipment QQ132 may include input interfaces, devices and circuits, and output interfaces, devices and circuits. User interface equipment QQ132 is configured to allow input of information into WD QQ110 and is connected to processing circuitry QQ120 to allow processing circuitry QQ120 to process the input information. User interface equipment QQ132 may include, for example, a microphone, a proximity or other sensor, keys/buttons, a touch display, one or more cameras, a USB port, or other input circuitry. User interface equipment QQ132 is also configured to allow output of information from WD QQ110, and to allow processing circuitry QQ120 to output information from WD QQ110. User interface equipment QQ132 may include, for example, a speaker, a display, vibrating circuitry, a USB port, a headphone interface, or other output circuitry. Using one or more input and output interfaces, devices, and circuits, of user interface equipment QQ132, WD QQ110 may communicate with end users and/or the wireless network and allow them to benefit from the functionality described herein.

Auxiliary equipment QQ134 is operable to provide more specific functionality which may not be generally performed by WDs. This may comprise specialized sensors for doing measurements for various purposes, interfaces for additional types of communication such as wired communications etc. The inclusion and type of components of auxiliary equipment QQ134 may vary depending on the embodiment and/or scenario.

Power source QQ136 may, in some embodiments, be in the form of a battery or battery pack. Other types of power sources, such as an external power source (e.g., an electricity outlet), photovoltaic devices or power cells, may also be used. WD QQ110 may further comprise power circuitry QQ137 for delivering power from power source QQ136 to the various parts of WD QQ110 which need power from power source QQ136 to carry out any functionality described or indicated herein. Power circuitry QQ137 may in certain embodiments comprise power management circuitry. Power circuitry QQ137 may additionally or alternatively be operable to receive power from an external power source; in which case WD QQ110 may be connectable to the external power source (such as an electricity outlet) via input circuitry or an interface such as an electrical power cable. Power circuitry QQ137 may also in certain embodiments be operable to deliver power from an external power source to power source QQ136. This may be, for example, for the charging of power source QQ136. Power circuitry QQ137 may perform any formatting, converting, or other modification to the power from power source QQ136 to make the power suitable for the respective components of WD QQ110 to which power is supplied.

Figure QQ2 illustrates one embodiment of a UE in accordance with various aspects described herein. As used herein, a user equipment or UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter). UE QQ200 may be any UE identified by the 3rd Generation Partnership Project (3GPP), including a NB-IoT UE, a machine type communication (MTC) UE, and/or an enhanced MTC (eMTC) UE. UE QQ200, as illustrated in Figure QQ2, is one example of a WD configured for communication in accordance with one or more communication standards promulgated by the 3rd Generation Partnership Project (3GPP), such as 3GPP's GSM, UMTS, LTE, and/or 5G standards. As mentioned previously, the term WD and UE may be used interchangeable. Accordingly, although Figure QQ2 is a UE, the components discussed herein are equally applicable to a WD, and vice-versa.

In Figure QQ2, UE QQ200 includes processing circuitry QQ201 that is operatively coupled to input/output interface QQ205, radio frequency (RF) interface QQ209, network connection interface QQ211, memory QQ215 including random access memory (RAM) QQ217, read-only memory (ROM) QQ219, storage medium QQ221 or the like, communication subsystem QQ231, power source QQ213, and/or any other component, or any combination thereof. Storage medium QQ221 includes operating system QQ223, application program QQ225, and data QQ227. In other embodiments, storage medium QQ221 may include other similar types of information. Certain UEs may utilize all of the components shown in Figure QQ2, or only a subset of the components. The level of integration between the components may vary from one UE to another UE. Further, certain UEs may contain multiple instances of a component, such as multiple processors, memories, transceivers, transmitters, receivers, etc.

In Figure QQ2, processing circuitry QQ201 may be configured to process computer instructions and data. Processing circuitry QQ201 may be configured to implement any sequential state machine operative to execute machine instructions stored as machine-readable computer programs in the memory, such as one or more hardware-implemented state machines (e.g., in discrete logic, FPGA, ASIC, etc.); programmable logic together with appropriate firmware; one or more stored program, general-purpose processors, such as a microprocessor or Digital Signal Processor (DSP), together with appropriate software; or any combination of the above. For example, the processing circuitry QQ201 may include two central processing units (CPUs). Data may be information in a form suitable for use by a computer.

In the depicted embodiment, input/output interface QQ205 may be configured to provide a communication interface to an input device, output device, or input and output device. UE QQ200 may be configured to use an output device via input/output interface QQ205. An output device may use the same type of interface port as an input device. For example, a USB port may be used to provide input to and output from UE QQ200. The output device may be a speaker, a sound card, a video card, a display, a monitor, a printer, an actuator, an emitter, a smartcard, another output device, or any combination thereof. UE QQ200 may be configured to use an input device via input/output interface QQ205 to allow a user to capture information into UE QQ200. The input device may include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, another like sensor, or any combination thereof. For example, the input device may be an accelerometer, a magnetometer, a digital camera, a microphone, and an optical sensor.

In Figure QQ2, RF interface QQ209 may be configured to provide a communication interface to RF components such as a transmitter, a receiver, and an antenna. Network connection interface QQ211 may be configured to provide a communication interface to network QQ243a. Network QQ243a may encompass wired and/or wireless networks such as a local-area network (LAN), a wide-area network (WAN), a computer network, a wireless network, a telecommunications network, another like network or any combination thereof. For example, network QQ243a may comprise a Wi-Fi network. Network connection interface QQ211 may be configured to include a receiver and a transmitter interface used to communicate with one or more other devices over a communication network according to one or more communication protocols, such as Ethernet, TCP/IP, SONET, ATM, or the like. Network connection interface QQ211 may implement receiver and transmitter functionality appropriate to the communication network links (e.g., optical, electrical, and the like). The transmitter and receiver functions may share circuit components, software or firmware, or alternatively may be implemented separately.

RAM QQ217 may be configured to interface via bus QQ202 to processing circuitry QQ201 to provide storage or caching of data or computer instructions during the execution of software programs such as the operating system, application programs, and device drivers. ROM QQ219 may be configured to provide computer instructions or data to processing circuitry QQ201. For example, ROM QQ219 may be configured to store invariant low-level system code or data for basic system functions such as basic input and output (I/O), startup, or reception of keystrokes from a keyboard that are stored in a non-volatile memory. Storage medium QQ221 may be configured to include memory such as RAM, ROM, programmable read-only memory (PROM), erasable programmable read-only memory (EPROM), electrically erasable programmable read-only memory (EEPROM), magnetic disks, optical disks, floppy disks, hard disks, removable cartridges, or flash drives. In one example, storage medium QQ221 may be configured to include operating system QQ223, application program QQ225 such as a web browser application, a widget or gadget engine or another application, and data file QQ227. Storage medium QQ221 may store, for use by UE QQ200, any of a variety of various operating systems or combinations of operating systems.

Storage medium QQ221 may be configured to include a number of physical drive units, such as redundant array of independent disks (RAID), floppy disk drive, flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as a subscriber identity module or a removable user identity (SIM/RUIM) module, other memory, or any combination thereof. Storage medium QQ221 may allow UE QQ200 to access computer-executable instructions, application programs or the like, stored on transitory or non-transitory memory media, to off-load data, or to upload data. An article of manufacture, such as one utilizing a communication system may be tangibly embodied in storage medium QQ221, which may comprise a device readable medium.

In Figure QQ2, processing circuitry QQ201 may be configured to communicate with network QQ243b using communication subsystem QQ231. Network QQ243a and network QQ243b may be the same network or networks or different network or networks. Communication subsystem QQ231 may be configured to include one or more transceivers used to communicate with network QQ243b. For example, communication subsystem QQ231 may be configured to include one or more transceivers used to communicate with one or more remote transceivers of another device capable of wireless communication such as another WD, UE, or base station of a radio access network (RAN) according to one or more communication protocols, such as IEEE 802.QQ2, CDMA, WCDMA, GSM, LTE, UTRAN, WiMAX, or the like. Each transceiver may include transmitter QQ233 and/or receiver QQ235 to implement transmitter or receiver functionality, respectively, appropriate to the RAN links (e.g., frequency allocations and the like). Further, transmitter QQ233 and receiver QQ235 of each transceiver may share circuit components, software or firmware, or alternatively may be implemented separately.

In the illustrated embodiment, the communication functions of communication subsystem QQ231 may include data communication, voice communication, multimedia communication, short-range communications such as Bluetooth, near-field communication, location-based communication such as the use of the global positioning system (GPS) to determine a location, another like communication function, or any combination thereof. For example, communication subsystem QQ231 may include cellular communication, Wi-Fi communication, Bluetooth communication, and GPS communication. Network QQ243b may encompass wired and/or wireless networks such as a local-area network (LAN), a wide-area network (WAN), a computer network, a wireless network, a telecommunications network, another like network or any combination thereof. For example, network QQ243b may be a cellular network, a Wi-Fi network, and/or a near-field network. Power source QQ213 may be configured to provide alternating current (AC) or direct current (DC) power to components of UE QQ200.

The features, benefits and/or functions described herein may be implemented in one of the components of UE QQ200 or partitioned across multiple components of UE QQ200. Further, the features, benefits, and/or functions described herein may be implemented in any combination of hardware, software or firmware. In one example, communication subsystem QQ231 may be configured to include any of the components described herein. Further, processing circuitry QQ201 may be configured to communicate with any of such components over bus QQ202. In another example, any of such components may be represented by program instructions stored in memory that when executed by processing circuitry QQ201 perform the corresponding functions described herein. In another example, the functionality of any of such components may be partitioned between processing circuitry QQ201 and communication subsystem QQ231. In another example, the non-computationally intensive functions of any of such components may be implemented in software or firmware and the computationally intensive functions may be implemented in hardware.

Figure QQ3 is a schematic block diagram illustrating a virtualization environment QQ300 in which functions implemented by some embodiments may be virtualized. In the present context, virtualizing means creating virtual versions of apparatuses or devices which may include virtualizing hardware platforms, storage devices and networking resources. As used herein, virtualization can be applied to a node (e.g., a virtualized base station or a virtualized radio access node) or to a device (e.g., a UE, a wireless device or any other type of communication device) or components thereof and relates to an implementation in which at least a portion of the functionality is implemented as one or more virtual components (e.g., via one or more applications, components, functions, virtual machines or containers executing on one or more physical processing nodes in one or more networks).

In some embodiments, some or all the functions described herein may be implemented as virtual components executed by one or more virtual machines implemented in one or more virtual environments QQ300 hosted by one or more of hardware nodes QQ330. Further, in embodiments in which the virtual node is not a radio access node or does not require radio connectivity (e.g., a core network node), then the network node may be entirely virtualized.

The functions may be implemented by one or more applications QQ320 (which may alternatively be called software instances, virtual appliances, network functions, virtual nodes, virtual network functions, etc.) operative to implement some of the features, functions, and/or benefits of some of the embodiments disclosed herein. Applications QQ320 are run in virtualization environment QQ300 which provides hardware QQ330 comprising processing circuitry QQ360 and memory QQ390. Memory QQ390 contains instructions QQ395 executable by processing circuitry QQ360 whereby application QQ320 is operative to provide one or more of the features, benefits, and/or functions disclosed herein.

Virtualization environment QQ300, comprises general-purpose or special-purpose network hardware devices QQ330 comprising a set of one or more processors or processing circuitry QQ360, which may be commercial off-the-shelf (COTS) processors, dedicated Application Specific Integrated Circuits (ASICs), or any other type of processing circuitry including digital or analog hardware components or special purpose processors. Each hardware device may comprise memory QQ390-1 which may be non-persistent memory for temporarily storing instructions QQ395 or software executed by processing circuitry QQ360. Each hardware device may comprise one or more network interface controllers (NICs) QQ370, also known as network interface cards, which include physical network interface QQ380. Each hardware device may also include non-transitory, persistent, machine-readable storage media QQ390-2 having stored therein software QQ395 and/or instructions executable by processing circuitry QQ360. Software QQ395 may include any type of software including software for instantiating one or more virtualization layers QQ350 (also referred to as hypervisors), software to execute virtual machines QQ340 as well as software allowing it to execute functions, features and/or benefits described in relation with some embodiments described herein.

Virtual machines QQ340, comprise virtual processing, virtual memory, virtual networking or interface and virtual storage, and may be run by a corresponding virtualization layer QQ350 or hypervisor. Different embodiments of the instance of virtual appliance QQ320 may be implemented on one or more of virtual machines QQ340, and the implementations may be made in different ways.

During operation, processing circuitry QQ360 executes software QQ395 to instantiate the hypervisor or virtualization layer QQ350, which may sometimes be referred to as a virtual machine monitor (VMM). Virtualization layer QQ350 may present a virtual operating platform that appears like networking hardware to virtual machine QQ340.

As shown in Figure QQ3, hardware QQ330 may be a standalone network node with generic or specific components. Hardware QQ330 may comprise antenna QQ3225 and may implement some functions via virtualization. Alternatively, hardware QQ330 may be part of a larger cluster of hardware (e.g., such as in a data center or customer premise equipment (CPE)) where many hardware nodes work together and are managed via management and orchestration (MANO) QQ3100, which, among others, oversees lifecycle management of applications QQ320.

Virtualization of the hardware is in some contexts referred to as network function virtualization (NFV). NFV may be used to consolidate many network equipment types onto industry standard high volume server hardware, physical switches, and physical storage, which can be in data centers, and customer premise equipment.

In the context of NFV, virtual machine QQ340 may be a software implementation of a physical machine that runs programs as if they were executing on a physical, non-virtualized machine. Each of virtual machines QQ340, and that part of hardware QQ330 that executes that virtual machine, be it hardware dedicated to that virtual machine and/or hardware shared by that virtual machine with others of the virtual machines QQ340, forms a separate virtual network element (VNE).

Still in the context of NFV, Virtual Network Function (VNF) is responsible for handling specific network functions that run in one or more virtual machines QQ340 on top of hardware networking infrastructure QQ330 and corresponds to application QQ320 in Figure QQ3.

In some embodiments, one or more radio units QQ3200 that each include one or more transmitters QQ3220 and one or more receivers QQ3210 may be coupled to one or more antennas QQ3225. Radio units QQ3200 may communicate directly with hardware nodes QQ330 via one or more appropriate network interfaces and may be used in combination with the virtual components to provide a virtual node with radio capabilities, such as a radio access node or a base station.

In some embodiments, some signalling can be effected with the use of control system QQ3230 which may alternatively be used for communication between the hardware nodes QQ330 and radio units QQ3200.

Figure QQ4 illustrates a telecommunication network connected via an intermediate network to a host computer in accordance with some embodiments. In particular, with reference to FIGURE QQ4, in accordance with an embodiment, a communication system includes telecommunication network QQ410, such as a 3GPP-type cellular network, which comprises access network QQ411, such as a radio access network, and core network QQ414. Access network QQ411 comprises a plurality of base stations QQ412a, QQ412b, QQ412c, such as NBs, eNBs, gNBs or other types of wireless access points, each defining a corresponding coverage area QQ413a, QQ413b, QQ413c. Each base station QQ412a, QQ412b, QQ412c is connectable to core network QQ414 over a wired or wireless connection QQ415. A first UE QQ491 located in coverage area QQ413c is configured to wirelessly connect to, or be paged by, the corresponding base station QQ412c. A second UE QQ492 in coverage area QQ413a is wirelessly connectable to the corresponding base station QQ412a. While a plurality of UEs QQ491, QQ492 are illustrated in this example, the disclosed embodiments are equally applicable to a situation where a sole UE is in the coverage area or where a sole UE is connecting to the corresponding base station QQ412.

Telecommunication network QQ410 is itself connected to host computer QQ430, which may be embodied in the hardware and/or software of a standalone server, a cloud-implemented server, a distributed server or as processing resources in a server farm. Host computer QQ430 may be under the ownership or control of a service provider or may be operated by the service provider or on behalf of the service provider. Connections QQ421 and QQ422 between telecommunication network QQ410 and host computer QQ430 may extend directly from core network QQ414 to host computer QQ430 or may go via an optional intermediate network QQ420. Intermediate network QQ420 may be one of, or a combination of more than one of, a public, private or hosted network; intermediate network QQ420, if any, may be a backbone network or the Internet; in particular, intermediate network QQ420 may comprise two or more sub-networks (not shown).

The communication system of Figure QQ4 as a whole enables connectivity between the connected UEs QQ491, QQ492 and host computer QQ430. The connectivity may be described as an over-the-top (OTT) connection QQ450. Host computer QQ430 and the connected UEs QQ491, QQ492 are configured to communicate data and/or signaling via OTT connection QQ450, using access network QQ411, core network QQ414, any intermediate network QQ420 and possible further infrastructure (not shown) as intermediaries. OTT connection QQ450 may be transparent in the sense that the participating communication devices through which OTT connection QQ450 passes are unaware of routing of uplink and downlink communications. For example, base station QQ412 may not or need not be informed about the past routing of an incoming downlink communication with data originating from host computer QQ430 to be forwarded (e.g., handed over) to a connected UE QQ491. Similarly, base station QQ412 need not be aware of the future routing of an outgoing uplink communication originating from the UE QQ491 towards the host computer QQ430.

Example implementations, in accordance with an embodiment, of the UE, base station and host computer discussed in the preceding paragraphs will now be described with reference to Figure QQ5. Figure QQ5 illustrates host computer communicating via a base station with a user equipment over a partially wireless connection in accordance with some embodiments In communication system QQ500, host computer QQ510 comprises hardware QQ515 including communication interface QQ516 configured to set up and maintain a wired or wireless connection with an interface of a different communication device of communication system QQ500. Host computer QQ510 further comprises processing circuitry QQ518, which may have storage and/or processing capabilities. In particular, processing circuitry QQ518 may comprise one or more programmable processors, application-specific integrated circuits, field programmable gate arrays or combinations of these (not shown) adapted to execute instructions. Host computer QQ510 further comprises software QQ511, which is stored in or accessible by host computer QQ510 and executable by processing circuitry QQ518. Software QQ511 includes host application QQ512. Host application QQ512 may be operable to provide a service to a remote user, such as UE QQ530 connecting via OTT connection QQ550 terminating at UE QQ530 and host computer QQ510. In providing the service to the remote user, host application QQ512 may provide user data which is transmitted using OTT connection QQ550.

Communication system QQ500 further includes base station QQ520 provided in a telecommunication system and comprising hardware QQ525 enabling it to communicate with host computer QQ510 and with UE QQ530. Hardware QQ525 may include communication interface QQ526 for setting up and maintaining a wired or wireless connection with an interface of a different communication device of communication system QQ500, as well as radio interface QQ527 for setting up and maintaining at least wireless connection QQ570 with UE QQ530 located in a coverage area (not shown in Figure QQ5) served by base station QQ520. Communication interface QQ526 may be configured to facilitate connection QQ560 to host computer QQ510. Connection QQ560 may be direct or it may pass through a core network (not shown in Figure QQ5) of the telecommunication system and/or through one or more intermediate networks outside the telecommunication system. In the embodiment shown, hardware QQ525 of base station QQ520 further includes processing circuitry QQ528, which may comprise one or more programmable processors, application-specific integrated circuits, field programmable gate arrays or combinations of these (not shown) adapted to execute instructions. Base station QQ520 further has software QQ521 stored internally or accessible via an external connection.

Communication system QQ500 further includes UE QQ530 already referred to. UE hardware QQ535 may include radio interface QQ537 configured to set up and maintain wireless connection QQ570 with a base station serving a coverage area in which UE QQ530 is currently located. Hardware QQ535 of UE QQ530 further includes processing circuitry QQ538, which may comprise one or more programmable processors, application-specific integrated circuits, field programmable gate arrays or combinations of these (not shown) adapted to execute instructions. UE QQ530 further comprises software QQ531, which is stored in or accessible by UE QQ530 and executable by processing circuitry QQ538. Software QQ531 includes client application QQ532. Client application QQ532 may be operable to provide a service to a human or non-human user via UE QQ530, with the support of host computer QQ510. In host computer QQ510, an executing host application QQ512 may communicate with the executing client application QQ532 via OTT connection QQ550 terminating at UE QQ530 and host computer QQ510. In providing the service to the user, client application QQ532 may receive request data from host application QQ512 and provide user data in response to the request data. OTT connection QQ550 may transfer both the request data and the user data. Client application QQ532 may interact with the user to generate the user data that it provides.

It is noted that host computer QQ510, base station QQ520 and UE QQ530 illustrated in Figure QQ5 may be similar or identical to host computer QQ430, one of base stations QQ412a, QQ412b, QQ412c and one of UEs QQ491, QQ492 of Figure QQ4, respectively. This is to say, the inner workings of these entities may be as shown in Figure QQ5 and independently, the surrounding network topology may be that of Figure QQ4.

In Figure QQ5, OTT connection QQ550 has been drawn abstractly to illustrate the communication between host computer QQ510 and UE QQ530 via base station QQ520, without explicit reference to any intermediary devices and the precise routing of messages via these devices. Network infrastructure may determine the routing, which it may be configured to hide from UE QQ530 or from the service provider operating host computer QQ510, or both. While OTT connection QQ550 is active, the network infrastructure may further take decisions by which it dynamically changes the routing (e.g., on the basis of load balancing consideration or reconfiguration of the network).

Wireless connection QQ570 between UE QQ530 and base station QQ520 is in accordance with the teachings of the embodiments described throughout this disclosure. One or more of the various embodiments improve the performance of OTT services provided to UE QQ530 using OTT connection QQ550, in which wireless connection QQ570 forms the last segment.

A measurement procedure may be provided for the purpose of monitoring data rate, latency and other factors on which the one or more embodiments improve. There may further be an optional network functionality for reconfiguring OTT connection QQ550 between host computer QQ510 and UE QQ530, in response to variations in the measurement results. The measurement procedure and/or the network functionality for reconfiguring OTT connection QQ550 may be implemented in software QQ511 and hardware QQ515 of host computer QQ510 or in software QQ531 and hardware QQ535 of UE QQ530, or both. In embodiments, sensors (not shown) may be deployed in or in association with communication devices through which OTT connection QQ550 passes; the sensors may participate in the measurement procedure by supplying values of the monitored quantities exemplified above or supplying values of other physical quantities from which software QQ511, QQ531 may compute or estimate the monitored quantities. The reconfiguring of OTT connection QQ550 may include message format, retransmission settings, preferred routing etc.; the reconfiguring need not affect base station QQ520, and it may be unknown or imperceptible to base station QQ520. Such procedures and functionalities may be known and practiced in the art. In certain embodiments, measurements may involve proprietary UE signaling facilitating host computer QQ510's measurements of throughput, propagation times, latency and the like. The measurements may be implemented in that software QQ511 and QQ531 causes messages to be transmitted, in particular empty or ‘dummy’ messages, using OTT connection QQ550 while it monitors propagation times, errors etc.

Figure QQ6 is a flowchart illustrating a method implemented in a communication system, in accordance with one embodiment. The communication system includes a host computer, a base station and a UE which may be those described with reference to Figures QQ4 and QQ5. For simplicity of the present disclosure, only drawing references to Figure QQ6 will be included in this section. In step QQ610, the host computer provides user data. In sub step QQ611 (which may be optional) of step QQ610, the host computer provides the user data by executing a host application. In step QQ620, the host computer initiates a transmission carrying the user data to the UE. In step QQ630 (which may be optional), the base station transmits to the UE the user data which was carried in the transmission that the host computer initiated, in accordance with the teachings of the embodiments described throughout this disclosure. In step QQ640 (which may also be optional), the UE executes a client application associated with the host application executed by the host computer.

Figure QQ7 is a flowchart illustrating a method implemented in a communication system, in accordance with one embodiment. The communication system includes a host computer, a base station and a UE which may be those described with reference to Figures QQ4 and QQ5. For simplicity of the present disclosure, only drawing references to Figure QQ7 will be included in this section. In step QQ710 of the method, the host computer provides user data. In an optional sub step (not shown) the host computer provides the user data by executing a host application. In step QQ720, the host computer initiates a transmission carrying the user data to the UE. The transmission may pass via the base station, in accordance with the teachings of the embodiments described throughout this disclosure. In step QQ730 (which may be optional), the UE receives the user data carried in the transmission.

Figure QQ8 is a flowchart illustrating a method implemented in a communication system, in accordance with one embodiment. The communication system includes a host computer, a base station and a UE which may be those described with reference to Figures QQ4 and QQ5. For simplicity of the present disclosure, only drawing references to Figure QQ8 will be included in this section. In step QQ810 (which may be optional), the UE receives input data provided by the host computer. Additionally or alternatively, in step QQ820, the UE provides user data. In sub step QQ821 (which may be optional) of step QQ820, the UE provides the user data by executing a client application. In sub step QQ811 (which may be optional) of step QQ810, the UE executes a client application which provides the user data in reaction to the received input data provided by the host computer. In providing the user data, the executed client application may further consider user input received from the user. Regardless of the specific manner in which the user data was provided, the UE initiates, in sub step QQ830 (which may be optional), transmission of the user data to the host computer. In step QQ840 of the method, the host computer receives the user data transmitted from the UE, in accordance with the teachings of the embodiments described throughout this disclosure.

Figure QQ9 is a flowchart illustrating a method implemented in a communication system, in accordance with one embodiment. The communication system includes a host computer, a base station and a UE which may be those described with reference to Figures QQ4 and QQ5. For simplicity of the present disclosure, only drawing references to Figure QQ9 will be included in this section. In step QQ910 (which may be optional), in accordance with the teachings of the embodiments described throughout this disclosure, the base station receives user data from the UE. In step QQ920 (which may be optional), the base station initiates transmission of the received user data to the host computer. In step QQ930 (which may be optional), the host computer receives the user data carried in the transmission initiated by the base station.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

In view of the above, then, embodiments herein generally include a communication system including a host computer. The host computer may comprise processing circuitry configured to provide user data. The host computer may also comprise a communication interface configured to forward the user data to a cellular network for transmission to a user equipment (UE). The cellular network may comprise a base station having a radio interface and processing circuitry, the base station's processing circuitry configured to perform any of the steps of any of the embodiments described above for a base station.

In some embodiments, the communication system further includes the base station.

In some embodiments, the communication system further includes the UE, wherein the UE is configured to communicate with the base station.

In some embodiments, the communication system further includes a location server, wherein the location server is configured to communicate with any one or more of the UE, the host computer, and the base station.

In some embodiments, the processing circuitry of the host computer is configured to execute a host application, thereby providing the user data. In this case, the UE comprises processing circuitry configured to execute a client application associated with the host application.

Embodiments herein also include a method implemented in a communication system including a host computer, a base station and a user equipment (UE), and, in at least some embodiments, a location server. The method comprises, at the host computer, providing user data. The method may also comprise, at the host computer, initiating a transmission carrying the user data to the UE via a cellular network comprising the base station. The base station performs any of the steps of any of the embodiments described above for a base station.

In some embodiments, the method further comprising, at the base station, transmitting the user data.

In some embodiments, the user data is provided at the host computer by executing a host application. In this case, the method further comprises, at the UE, executing a client application associated with the host application.

Embodiments herein also include a user equipment (UE) configured to communicate with a base station. The UE comprises a radio interface and processing circuitry configured to perform any of the embodiments above described for a UE.

Embodiments herein further include a communication system including a host computer. The host computer comprises processing circuitry configured to provide user data, and a communication interface configured to forward user data to a cellular network for transmission to a user equipment (UE). The UE comprises a radio interface and processing circuitry. The UE's components are configured to perform any of the steps of any of the embodiments described above for a UE.

In some embodiments, the cellular network further includes a base station configured to communicate with the UE.

In some embodiments, the processing circuitry of the host computer is configured to execute a host application, thereby providing the user data. The UE's processing circuitry is configured to execute a client application associated with the host application.

Embodiments also include a method implemented in a communication system including a host computer, a base station and a user equipment (UE). The method comprises, at the host computer, providing user data and initiating a transmission carrying the user data to the UE via a cellular network comprising the base station. The UE performs any of the steps of any of the embodiments described above for a UE.

In some embodiments, the method further comprises, at the UE, receiving the user data from the base station.

Embodiments herein further include a communication system including a host computer. The host computer comprises a communication interface configured to receive user data originating from a transmission from a user equipment (UE) to a base station. The UE comprises a radio interface and processing circuitry. The UE's processing circuitry is configured to perform any of the steps of any of the embodiments described above for a UE.

In some embodiments the communication system further includes the UE.

In some embodiments, the communication system further including the base station. In this case, the base station comprises a radio interface configured to communicate with the UE and a communication interface configured to forward to the host computer the user data carried by a transmission from the UE to the base station.

In some embodiments, the processing circuitry of the host computer is configured to execute a host application. And the UE's processing circuitry is configured to execute a client application associated with the host application, thereby providing the user data.

In some embodiments, the processing circuitry of the host computer is configured to execute a host application, thereby providing request data. And the UE's processing circuitry is configured to execute a client application associated with the host application, thereby providing the user data in response to the request data.

Embodiments herein also include a method implemented in a communication system including a host computer, a base station and a user equipment (UE). The method comprises, at the host computer, receiving user data transmitted to the base station from the UE. The UE performs any of the steps of any of the embodiments described above for the UE.

In some embodiments, the method further comprises, at the UE, providing the user data to the base station.

In some embodiments, the method also comprises, at the UE, executing a client application, thereby providing the user data to be transmitted. The method may further comprise, at the host computer, executing a host application associated with the client application.

In some embodiments, the method further comprises, at the UE, executing a client application, and, at the UE, receiving input data to the client application. The input data is provided at the host computer by executing a host application associated with the client application. The user data to be transmitted is provided by the client application in response to the input data.

Embodiments also include a communication system including a host computer. The host computer comprises a communication interface configured to receive user data originating from a transmission from a user equipment (UE) to a base station. The base station comprises a radio interface and processing circuitry. The base station's processing circuitry is configured to perform any of the steps of any of the embodiments described above for a base station.

In some embodiments, the communication system further includes the base station.

In some embodiments, the communication system further includes the UE. The UE is configured to communicate with the base station.

In some embodiments, the processing circuitry of the host computer is configured to execute a host application. And the UE is configured to execute a client application associated with the host application, thereby providing the user data to be received by the host computer.

Embodiments moreover include a method implemented in a communication system including a host computer, a base station and a user equipment (UE). The method comprises, at the host computer, receiving, from the base station, user data originating from a transmission which the base station has received from the UE. The UE performs any of the steps of any of the embodiments described above for a UE.

In some embodiments, the method further comprises, at the base station, receiving the user data from the UE.

In some embodiments, the method further comprises, at the base station, initiating a transmission of the received user data to the host computer.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the description.

The term unit may have conventional meaning in the field of electronics, electrical devices and/or electronic devices and may include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

The term “A and/or B” as used herein covers embodiments having A alone, B alone, or both A and B together. The term “A and/or B” may therefore equivalently mean “at least one of any one or more of A and B”.

Some of the embodiments contemplated herein are described more fully with reference to the accompanying drawings. Other embodiments, however, are contained within the scope of the subject matter disclosed herein. The disclosed subject matter should not be construed as limited to only the embodiments set forth herein; rather, these embodiments are provided by way of example to convey the scope of the subject matter to those skilled in the art.

### EXAMPLE EMBODIMENTS

### Group A Embodiments

A1. A method performed by a wireless device, the method comprising:
receiving configuration information configuring the wireless device to support positioning of the wireless device as a function of signal measurements made with respect to one or more non-terrestrial radio links between the wireless device and one or more non-terrestrial network nodes; and
transmitting uplink (UL) signals to support the positioning of the wireless device, in accordance with the configuration information.

A2. The method of embodiment A1, wherein the method further comprises communicating with a location server in a communication network that includes the one or more non-terrestrial network nodes via an extended version of the LTE Positioning Protocol (LPP), as extended to provide for measurement and configuration information specific to positioning using non-terrestrial radio links.

A3. The method of embodiment A1 or A2, further comprising reporting capability information to a location server or another network node of a communication network that includes the one or more non-terrestrial network nodes, the reporting done autonomously or responsive to receiving a request and indicating capabilities of the wireless device regarding support for positioning of the wireless device using non-terrestrial radio links.

A4. The method of any of the Group A embodiments, wherein transmitting the UL signals in accordance with the configuration information comprises transmitting UL Sounding Reference Signals (SRS) with one or more physical-layer characteristics specified for positioning via radio signals propagated over non-terrestrial radio links.

A5. The method of embodiment A4, wherein the one or more physical-layer characteristics include any one or more of: sequence parameters, bandwidth, SCS or symbol length, cyclic prefix, sequence generation, frequency or frequency band, and repetition factor.

A6. The method of any of the Group A embodiments, wherein transmitting the UL signals in accordance with the configuration information comprises transmitting the UL signals on specified radio resources, and wherein the UL signals are transmitted on a frequency or frequencies reserved for non-terrestrial radio use, or are transmitted using a repetition factor that compensates for a propagation path length associated with use of the one or more non-terrestrial network nodes for receiving the UL signals.

AA. The method of any of the previous embodiments, further comprising:
providing user data; and
forwarding the user data to a host computer via the transmission to a base station.

### Group B Embodiments

B1. A method performed by a non-terrestrial network node, the method comprising:
reporting one or more parameters associated with a non-terrestrial uplink (UL) path associated with a wireless device to be positioned, the one or more parameters including a least one of a propagation delay value associated with the non-terrestrial UL path and a transmit repetition factor used by the wireless device for uplink transmissions, the one or more parameters reported to a location server that accounts for the one or more parameters for positioning of the wireless device.

B2. The method of embodiment B1, further comprising communicating with the location server according to an extended version of NRPPa, as extended to provide for measurement and configuration information specific to positioning using radio signals propagated over non-terrestrial radio links.

B3. The method of embodiment B1 or B2, further comprising reporting capability information to a location server or another network node of a communication network, regarding capabilities of the non-terrestrial network node for regarding positioning of wireless devices using non-terrestrial radio links, the reporting done autonomously or responsive to receiving a request.

B4. A method performed by a non-terrestrial network node, the method comprising:
determining a configuration for uplink (UL) signals to be received from a wireless device via a non-terrestrial radio link between the wireless device and a non-terrestrial reception point included in or coupled to the non-terrestrial network node;
performing positioning-related measurements on the UL signals; and
reporting the positioning-related measurements or results derived therefrom, to a location server.

BB. The method of any of the previous embodiments, further comprising:
obtaining user data; and
forwarding the user data to a host computer or a wireless device.

### Group C Embodiments

C1. A method performed by a location server, the method comprising:
receiving information indicating one or more parameters associated with a non-terrestrial radio link between the wireless device and a non-terrestrial transmission/reception point, the one or more parameters being at least one of a delay associated with the non-terrestrial radio link and a repetition factor used by the wireless device for repeating UL transmissions; and
determining positioning configuration or assistance data for at least one of: one or more non-terrestrial network nodes to be used for receiving UL signals from the wireless device, for positioning measurements, one or more non-terrestrial network node to be used for transmitting downlink (DL) signals for positioning measurements by the wireless device, and the wireless device.

C2. The method of embodiment C1, further comprising communicating with non-terrestrial network nodes for positioning of the wireless device according to an extended version of NRPPa, as extended to provide for measurement and configuration information specific to positioning using radio signals propagated over non-terrestrial radio links.

C3. The method of embodiment C1 or C2, further comprising communicating with the wireless device according to an extended version of NRLPP, as extended to provide for measurement and configuration information specific to positioning using radio signals propagated over non-terrestrial radio links.

C4. The method of any of embodiments C1-C3, further comprising receiving capability information from the wireless device and/or from one or more non-terrestrial network nodes, regarding capabilities for positioning the wireless device using non-terrestrial radio links, the reporting done autonomously or responsive to the location server sending requests.

CC. The method of any of the previous embodiments, further comprising:
obtaining location data; and
forwarding the location data to a host computer or a wireless device.

### Group D Embodiments

D1. A wireless device configured to perform any of the steps of any of the Group A embodiments.

D2. A wireless device comprising processing circuitry configured to perform any of the steps of any of the Group A embodiments.

D3. A wireless device comprising:
communication circuitry; and
processing circuitry configured to perform any of the steps of any of the Group A embodiments.

D4. A wireless device comprising:
processing circuitry configured to perform any of the steps of any of the Group A embodiments; and
power supply circuitry configured to supply power to the wireless device.

D5. A wireless device comprising:
processing circuitry and memory, the memory containing instructions executable by the processing circuitry whereby the wireless device is configured to perform any of the steps of any of the Group A embodiments.

D6. A user equipment (UE) comprising:
an antenna configured to send and receive wireless signals;
radio front-end circuitry connected to the antenna and to processing circuitry, and configured to condition signals communicated between the antenna and the processing circuitry;
the processing circuitry being configured to perform any of the steps of any of the Group A embodiments;
an input interface connected to the processing circuitry and configured to allow input of information into the UE to be processed by the processing circuitry;
an output interface connected to the processing circuitry and configured to output information from the UE that has been processed by the processing circuitry; and
a battery connected to the processing circuitry and configured to supply power to the UE.

D7. A computer program comprising instructions which, when executed by at least one processor of a wireless device, causes the wireless device to carry out the steps of any of the Group A embodiments.

D8. A carrier containing the computer program of embodiment D7, wherein the carrier of the computer program is one of an electronic signal, optical signal, radio signal, or computer readable storage medium.

D9. A radio network node configured to perform any of the steps of any of the Group B embodiments.

D10. A radio network node comprising processing circuitry configured to perform any of the steps of any of the Group B embodiments.

D11. A radio network node comprising:
communication circuitry; and
processing circuitry configured to perform any of the steps of any of the Group B embodiments.

D12. A radio network node comprising:
processing circuitry configured to perform any of the steps of any of the Group B embodiments; and
power supply circuitry configured to supply power to the radio network node.

D13. A radio network node comprising:
processing circuitry and memory, the memory containing instructions executable by the processing circuitry whereby the radio network node is configured to perform any of the steps of any of the Group B embodiments.

D14. The radio network node of any of embodiments D9-D13, wherein the radio network node is a base station.

D15. A computer program comprising instructions which, when executed by at least one processor of a radio network node, causes the radio network node to carry out the steps of any of the Group B embodiments.

D16. The computer program of embodiment D15, wherein the radio network node is a base station.

D17. A carrier containing the computer program of any of embodiments D15-D16, wherein the carrier is one of an electronic signal, optical signal, radio signal, or computer readable storage medium.

D18. A location server configured to perform any of the steps of any of the Group C embodiments.

D19. A location server comprising processing circuitry configured to perform any of the steps of any of the Group C embodiments.

D20. A location server comprising:
communication circuitry; and
processing circuitry configured to perform any of the steps of any of the Group C embodiments.

D21. A location server comprising:
processing circuitry configured to perform any of the steps of any of the Group C embodiments; and
power supply circuitry configured to supply power to the location server.

D22. A location server comprising:
processing circuitry and memory, the memory containing instructions executable by the processing circuitry whereby the location server is configured to perform any of the steps of any of the Group C embodiments.

D23. A computer program comprising instructions which, when executed by at least one processor of a location server, causes the location server to carry out the steps of any of the Group C embodiments.

D24. A carrier containing the computer program of embodiment D23, wherein the carrier is one of an electronic signal, optical signal, radio signal, or computer readable storage medium.

### Group E Embodiments

E1. A communication system including a host computer comprising:
processing circuitry configured to provide user data; and
a communication interface configured to forward the user data to a cellular network for transmission to a user equipment (UE),
wherein the cellular network comprises a base station having a radio interface and processing circuitry, the base station's processing circuitry configured to perform any of the steps of any of the Group B embodiments.

E2. The communication system of the previous embodiment further including the base station.

E3. The communication system of the previous 2 embodiments, further including the UE, wherein the UE is configured to communicate with the base station.

E4. The communication system of the previous 3 embodiments, wherein:
the processing circuitry of the host computer is configured to execute a host application, thereby providing the user data; and
the UE comprises processing circuitry configured to execute a client application associated with the host application.

E5. A method implemented in a communication system including a host computer, a base station and a user equipment (UE), the method comprising:
at the host computer, providing user data; and
at the host computer, initiating a transmission carrying the user data to the UE via a cellular network comprising the base station, wherein the base station performs any of the steps of any of the Group B embodiments.

E6. The method of the previous embodiment, further comprising, at the base station, transmitting the user data.

E7. The method of the previous 2 embodiments, wherein the user data is provided at the host computer by executing a host application, the method further comprising, at the UE, executing a client application associated with the host application.

E8. A user equipment (UE) configured to communicate with a base station, the UE comprising a radio interface and processing circuitry configured to perform any of the previous 3 embodiments.

E9. A communication system including a host computer comprising:
processing circuitry configured to provide user data; and
a communication interface configured to forward user data to a cellular network for transmission to a user equipment (UE),
wherein the UE comprises a radio interface and processing circuitry, the UE's components configured to perform any of the steps of any of the Group A embodiments.

E10. The communication system of the previous embodiment, wherein the cellular network further includes a base station configured to communicate with the UE.

E11. The communication system of the previous 2 embodiments, wherein the communication system further comprises a location server configured to perform any of the steps of any of the Group C embodiments.

E12. The communication system of any of the previous 3 embodiments, wherein:
the processing circuitry of the host computer is configured to execute a host application, thereby providing the user data; and
the UE's processing circuitry is configured to execute a client application associated with the host application.

E13. A method implemented in a communication system including a host computer, a base station and a user equipment (UE), the method comprising:
at the host computer, providing user data; and
at the host computer, initiating a transmission carrying the user data to the UE via a cellular network comprising the base station, wherein the UE performs any of the steps of any of the Group A embodiments.

E14. The method of the previous embodiment, further comprising at the UE, receiving the user data from the base station.

E15. A communication system including a host computer comprising:
communication interface configured to receive user data originating from a transmission from a user equipment (UE) to a base station,
wherein the UE comprises a radio interface and processing circuitry, the UE's processing circuitry configured to perform any of the steps of any of the Group A embodiments.

E16. The communication system of the previous embodiment, further including the UE.

E17. The communication system of the previous 2 embodiments, further including the base station, wherein the base station comprises a radio interface configured to communicate with the UE and a communication interface configured to forward to the host computer the user data carried by a transmission from the UE to the base station.

E18. The communication system of the previous 3 embodiments, wherein:
the processing circuitry of the host computer is configured to execute a host application; and
the UE's processing circuitry is configured to execute a client application associated with the host application, thereby providing the user data.

E19. The communication system of the previous 4 embodiments, wherein:
the processing circuitry of the host computer is configured to execute a host application, thereby providing request data; and
the UE's processing circuitry is configured to execute a client application associated with the host application, thereby providing the user data in response to the request data.

E20. A method implemented in a communication system including a host computer, a base station and a user equipment (UE), the method comprising:
at the host computer, receiving user data transmitted to the base station from the UE,
   wherein the UE performs any of the steps of any of the Group A embodiments.

E21. The method of the previous embodiment, further comprising, at the UE, providing the user data to the base station.

E22. The method of the previous 2 embodiments, further comprising:
at the UE, executing a client application, thereby providing the user data to be transmitted; and
at the host computer, executing a host application associated with the client application.

E23. The method of the previous 3 embodiments, further comprising:
at the UE, executing a client application; and
at the UE, receiving input data to the client application, the input data being provided at the host computer by executing a host application associated with the client application,
wherein the user data to be transmitted is provided by the client application in response to the input data.

E24. A communication system including a host computer comprising a communication interface configured to receive user data originating from a transmission from a user equipment (UE) to a base station, wherein the base station comprises a radio interface and processing circuitry, the base station's processing circuitry configured to perform any of the steps of any of the Group B embodiments.

E25. The communication system of the previous embodiment further including the base station.

E26. The communication system of the previous 2 embodiments, further including the UE, wherein the UE is configured to communicate with the base station.

E27. The communication system of the previous 3 embodiments, wherein:
the processing circuitry of the host computer is configured to execute a host application; and
the UE is configured to execute a client application associated with the host application, thereby providing the user data to be received by the host computer.

E28. A method implemented in a communication system including a host computer, a base station and a user equipment (UE), the method comprising:
at the host computer, receiving, from the base station, user data originating from a transmission which the base station has received from the UE, wherein the UE performs any of the steps of any of the Group A embodiments.

E29. The method of the previous embodiment, further comprising, at the base station, receiving the user data from the UE.

E30. The method of the previous 2 embodiments, further comprising, at the base station, initiating a transmission of the received user data to the host computer.

### Abbreviations

At least some of the following abbreviations may be used in this disclosure. If there is an inconsistency between abbreviations, preference should be given to how it is used above. If listed multiple times below, the first listing should be preferred over any subsequent listing(s).
1x RTT CDMA2000 1x Radio Transmission Technology
3GPP 3rd Generation Partnership Project
5G 5th Generation
ABS Almost Blank Subframe
ARQ Automatic Repeat Request
AWGN Additive White Gaussian Noise
BCCH Broadcast Control Channel
BCH Broadcast Channel
CA Carrier Aggregation
CC Carrier Component
CCCH SDU Common Control Channel SDU
CDMA Code Division Multiplexing Access
CE Control Element
CGI Cell Global Identifier
CIR Channel Impulse Response
CP Cyclic Prefix
CPICH Common Pilot Channel
CPICH Ec/No CPICH Received energy per chip divided by the power density in the band
CQI Channel Quality information
C-RNTI Cell RNTI
CSI Channel State Information
DCCH Dedicated Control Channel
DCI Downlink Control Information
DL Downlink
DM Demodulation
DMRS Demodulation Reference Signal
DRB Data Radio Bearer
DRX Discontinuous Reception
DTX Discontinuous Transmission
DTCH Dedicated Traffic Channel
DU Digital Unit
DUT Device Under Test
E-CID Enhanced Cell-ID (positioning method)
E-SMLC Evolved-Serving Mobile Location Centre
ECGI Evolved CGI
eNB E-UTRAN NodeB
ePDCCH enhanced Physical Downlink Control Channel
E-SMLC evolved Serving Mobile Location Center
E-UTRA Evolved UTRA
E-UTRAN Evolved UTRAN
FDD Frequency Division Duplex
FFS For Further Study
GEO Geosynchronous
GERAN GSM EDGE Radio Access Network
gNB Base station in NR
GNSS Global Navigation Satellite System
GSM Global System for Mobile communication
HARQ Hybrid Automatic Repeat Request
HO Handover
HSPA High Speed Packet Access
HRPD High Rate Packet Data
ISL Inter-Satellite Link
LOS Line of Sight
LPP LTE Positioning Protocol
LTE Long-Term Evolution
MAC Medium Access Control
MBMS Multimedia Broadcast Multicast Services
MBSFN Multimedia Broadcast multicast service Single Frequency Network
MBSFN ABS MBSFN Almost Blank Subframe
MDT Minimization of Drive Tests
MIB Master Information Block
MME Mobility Management Entity
MSC Mobile Switching Center
NON-GEO non-Geosynchronous
NPDCCH Narrowband Physical Downlink Control Channel
NR New Radio
NTN Non-Terrestrial Network
OCNG OFDMA Channel Noise Generator
OFDM Orthogonal Frequency Division Multiplexing
OFDMA Orthogonal Frequency Division Multiple Access
OSS Operations Support System
OTDOA Observed Time Difference of Arrival
O&M Operation and Maintenance
PBCH Physical Broadcast Channel
P-CCPCH Primary Common Control Physical Channel
PCell Primary Cell
PCFICH Physical Control Format Indicator Channel
PDCCH Physical Downlink Control Channel
PDP Profile Delay Profile
PDSCH Physical Downlink Shared Channel
PGW Packet Gateway
PHICH Physical Hybrid-ARQ Indicator Channel
PLMN Public Land Mobile Network
PMI Precoder Matrix Indicator
PRACH Physical Random Access Channel
PRS Positioning Reference Signal
PSCELL Primary Secondary Cell
PSS Primary Synchronization Signal
PUCCH Physical Uplink Control Channel
PUSCH Physical Uplink Shared Channel
QAM Quadrature Amplitude Modulation
RACH Random Access Channel
RAN Radio Access Network
RAT Radio Access Technology
RLF Radio Link Failure
RLM Radio Link Management
RNC Radio Network Controller
RNTI Radio Network Temporary Identifier
RRC Radio Resource Control
RRM Radio Resource Management
RS Reference Signal
RSCP Received Signal Code Power
RSRP Reference Symbol Received Power OR Reference Signal Received Power
RSRQ Reference Signal Received Quality OR Reference Symbol Received Quality
RSSI Received Signal Strength Indicator
RSTD Reference Signal Time Difference
SAT Satellite
SCH Synchronization Channel
SCell Secondary Cell
SDU Service Data Unit
SFN System Frame Number
SGW Serving Gateway
SI System Information
SIB System Information Block
SMTC SS/PBCH Block Measurement Time Configuration
SNR Signal to Noise Ratio
SON Self Optimized Network
SR Scheduling Request
SRB Signaling Radio Bearer
SRI Satellite Radio Interface
SS Synchronization Signal
SSS Secondary Synchronization Signal
TDD Time Division Duplex
TDoA Time Difference of Arrival
ToA Time of Arrival
TSS Tertiary Synchronization Signal
TTI Transmission Time Interval
UAS Unmanned Aircraft System
UE User Equipment
UL Uplink
UMTS Universal Mobile Telecommunication System
USIM Universal Subscriber Identity Module
UTDOA Uplink Time Difference of Arrival
UTRA Universal Terrestrial Radio Access
UTRAN Universal Terrestrial Radio Access Network
WCDMA Wide CDMA
WLAN Wide Local Area Network

1-32. (Canceled)

33. A method of supporting multiple cell round trip time (multi-RTT) measurements involving a user equipment (UE), where at least one of the multiple cells is associated with a non-terrestrial network (NTN) node, wherein the NTN node comprises a gNodeB (gNB) capable of NTN operation, the method performed by the NTN node and comprising:
determining propagation delay information associated with one or both of a feeder link between the NTN node and a ground station, or a service link between the NTN node and the UE; and
sending the propagation delay information to a location server, for determination of multi-RTT assistance data.

34. The method according to claim 33, wherein the location server is a node in a core network (CN) of a wireless communication network that includes the NTN and further includes one or more terrestrial network nodes that provide at least one other cell of the multiple cells.

35. The method according to claim 33, wherein the propagation delay information indicates a service-link propagation delay and/or a feeder-link propagation delay.

36. The method according to claim 33, wherein the propagation delay information comprises one or more timing advance (TA) offsets used by the UE with respect to the NTN node, the one or more TA offsets bearing on downlink and uplink frame timing in the UE.

37. The method according to claim 33, wherein the NTN node is a base station implemented in a satellite or an unmanned aerial system (UAS).

38. The method according to claim 33, further comprising receiving the multi-RTT assistance data from the location server and performing at least one of:
performing measurements on one or more uplink (UL) signals received at the NTN node from the UE, according to the multi-RTT assistance data; and
passing the multi-RTT assistance data to the UE, for use by the UE in performing one or more downlink (DL) measurements on signals received at the UE from the NTN node.

39. The method according to claim 33, further comprising controlling a transmission timing of a downlink (DL) positioning reference signal (PRS) to be transmitted by the NTN node for the UE, according to the multi-RTT assistance data.

40. A non-terrestrial network (NTN) node configured to support multiple cell round trip time (multi-RTT) measurements involving a user equipment (UE), where at least one of the multiple cells is associated with the non-terrestrial network (NTN) node, wherein the NTN node comprises a gNodeB (gNB) capable of NTN operation, the NTN node comprising:
communication interface circuitry; and
processing circuitry configured to:
determine propagation delay information associated with one or both of a feeder link between the NTN node and a ground station, or a service link between the NTN node and the UE; and
send, via the communication interface circuitry, the propagation delay information to a location server, for determination of multi-RTT assistance data.

41. A method of supporting multiple cell round trip time (multi-RTT) measurements involving a user equipment (UE), where at least one of the multiple cells is associated with a non-terrestrial network (NTN) node, wherein the NTN node comprises a gNodeB (gNB) configured for NTN operation, the method performed by a location server and comprising:
receiving propagation delay information associated with one or both of a feeder link between the NTN node and a ground station, or a service link between the NTN node and the UE;
determining multi-RTT assistance data for the NTN node or the UE or both; and
sending the multi-RTT assistance data to the NTN node or the UE or both.

42. The method according to claim 41, wherein the location server is a node in a core network (CN) of a wireless communication network that includes the NTN and further includes one or more terrestrial network nodes that provide at least one other cell of the multiple cells.

43. The method according to claim 41, wherein the propagation delay information indicates a service-link propagation delay and/or a feeder-link propagation delay.

44. The method according to 41, wherein the propagation delay information comprises one or more timing advance (TA) offsets used by the UE with respect to the NTN node, the one or more TA offsets bearing on downlink and uplink frame timing in the UE.

45. A location server configured to support multiple cell round trip time (multi-RTT) measurements involving a user equipment (UE), where at least one of the multiple cells is associated with a non-terrestrial network (NTN) node, wherein the NTN node comprises a gNodeB (gNB) configured for NTN operation, the location server comprising:
communication interface circuitry; and
processing circuitry configured to:
receive, via the communication interface circuitry, propagation delay information associated with one or both of a feeder link between the NTN node and a ground station, or a service link between the NTN node and the UE;
determine multi-RTT assistance data for the NTN node or the UE or both; and
send, via the communication interface circuitry, the multi-RTT assistance data to the NTN node or the UE or both.
